(19) United States
(12) Patent Application Publication
(10) Pub. No.: US 2024/0095591 A1
(43) Pub. Date: Mar. 21, 2024

(54) PROCESSING DIFFERENT TIMESCALE DATA UTILIZING A MODEL

(71) Applicant: UnitedHealth Group Incorporated, Minnetonka, MN (US)

(72) Inventors: Gregory D. Lyng, Minneapolis, MN (US); Eran Halperin, Santa Monica, CA (US); Brian Lawrence Hill, Culver City, CA (US); Kimmo M. Karkkainen, Santa Monica, CA (US); Kailas Vodrahalli, Los Altos, CA (US)

(21) Appl. No.: 18/325,598

(22) Filed: May 30, 2023

Related U.S. Application Data
(60) Provisional application No. 63/376,460, filed on Sep. 21, 2022.

(51) Int. Cl. G06N 20/00

(52) U.S. Cl. CPC G06N 20/00

(57) ABSTRACT

Embodiments of the disclosure provide for improved processing of data with different timescales, for example high-frequency data and low-frequency data. Embodiments specifically improve such processing of different timescale data processed by a machine learning model. Additionally or alternatively, some embodiments include improved processing of data with different timescales by selecting an optimal variant from a plurality of possible variants of a prediction model.

### CROSS REFERENCE TO RELATED APPLICATION

This application claims the benefit of U.S. Provisional Application No. 63/376,460, entitled “Integration Of Multiple Temporal Scales Into A Deep Learning Architecture”, and filed Sep. 21, 2022, the entire contents of which are hereby incorporated by reference.

### TECHNICAL FIELD

Embodiments of the present disclosure are directed to improved processing of data for use with machine learning models, and specifically to improved processing of data having multiple timescales via machine learning models.

### BACKGROUND

In several use cases, a data-driven determination is performed based on multiple portions of input data. The input data may be collected or associated with different temporal scales, for example where one type of data is collected frequently, and one type of data is collected infrequently. Despite these differences in temporality of the input data, systems may attempt to process all such input data with a goal of yielding an accurate data-driven determination.

Applicant has discovered problems and/or other inefficiencies with current implementations of processing data associated with different temporal scales. Through applied effort, ingenuity, and innovation, Applicant has solved many of these identified problems by developing solutions embodied in the present disclosure, which are described in detail below.

### BRIEF SUMMARY

In one aspect, a computer-implemented method for processing different timescale data is provided. In one example the computer-implemented method includes receiving, by one or more processors, high-frequency data associated with a first capture rate and low-frequency data associated with a second capture rate. The computer-implemented method further includes generating, by the one or more processors, vectorized low frequency data by converting the low-frequency data using a low-frequency encoding model. The computer-implemented method further includes processing, by the one or more processors and utilizing a prediction model, the high-frequency data and the vectorized low-frequency data to generate output data.

In another aspect of the disclosure, a computing apparatus is provided. One example apparatus includes a processor and memory having computer-coded instructions stored thereon that, in execution with the processor, causes the computing apparatus to perform any one of the example computer-implemented methods described herein.

In another aspect of the disclosure, a computer program product is provided. One example computer program product comprises a non-transitory computer-readable storage medium, the non-transitory computer-readable storage medium including instructions that, when executed by a computing apparatus, cause the computing apparatus to perform any one of the example computer-implemented processes described herein.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example computing system 100 in accordance with one or more embodiments of the present disclosure

FIG. 2 is a schematic diagram showing a system computing architecture 200 in accordance with some embodiments discussed herein.

FIG. 3 illustrates a system diagram of an example system in accordance with at least one example embodiment of the present disclosure.

FIG. 4 illustrates a block diagram of an example apparatus that may be specially configured in accordance with at least one example embodiment of the present disclosure.

FIG. 5 illustrates an example improved multi-layer prediction model in accordance with at least one example embodiment of the present disclosure.

FIG. 6 illustrates an example encoding model with attention in accordance with at least one example embodiment of the present disclosure.

FIG. 7 illustrates an example representation of a performance data set for a plurality of variants in accordance with at least one example embodiment of the present disclosure.

FIG. 8 illustrates a process 800 for processing different timescale data in accordance with at least one example embodiment of the present disclosure.

FIG. 9 illustrates a process 900 for generating a plurality of variants of a prediction model, for example as a sub-process of processing different timescale data, in accordance with at least one example embodiment of the present disclosure.

FIG. 10 illustrates a process 1000 for utilizing an optimal variant to generate at least one state prediction, for example as a sub-process of processing different timescale data, in accordance with at least one example embodiment of the present disclosure.

FIG. 11 illustrates a process 1100 for utilizing an optimal variant to generate at least one missing data value, for example as a sub-process of processing different timescale data, in accordance with at least one example embodiment of the present disclosure.

FIG. 12 illustrates a process 1200 for receiving output truth source data, for example as a sub-process of processing different timescale data, in accordance with at least one example embodiment of the present disclosure.

FIG. 13 illustrates a process 1300 for generating vectorized low frequency data, for example as a sub-process of processing different timescale data, in accordance with at least one example embodiment of the present disclosure.

FIG. 14 illustrates a process 1400 for generating a set of time-by-code vectors, for example as a sub-process of processing different timescale data, in accordance with at least one example embodiment of the present disclosure.

FIG. 15 illustrates a process 1300 for converting at least one unique code to a code data vector, for example as a sub-process of processing different timescale data, in accordance with at least one example embodiment of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not indicate being based only on or based solely on the referenced element or elements unless so indicated. Like numbers refer to like elements throughout.

### Technical Problems and Technical Solutions

In several contexts, data inputs associated with different timescales are processed to perform any of a myriad of data-driven determinations. In some such contexts, it is desirable to process different timescale data inputs via a specially trained model, for example one or more machine-learning models, that perform a classification, prediction, or other machine learning task by learning data pattern(s), trend(s), and/or other learning(s) between the different timescale data. One specific example context within which such different timescale data processing is desirable is in the field of identifying particular activities and/or signals by processing a combination of health-related data sources corresponding to a patient, for example health sensor, wearable, or continuous monitoring device data (which is continuously or frequently collected at regular intervals), healthcare data from electronic medical records (which includes medical codes associated with the patient and is intermittently or otherwise infrequently collected compared to the high-frequency data of the sensor(s)), and patient demographic data (which is either immutable or relatively static). Continuing this example, such various data inputs may be processed to generate a particular output predicting whether a user is sleeping, walking, standing, a patient's heartbeat, and/or the like, for example by processing by a specially configured machine learning model. Another example context includes identifying a status of operation of a machine in a manufacturing facility by processing a combination of maintenance-related data sources corresponding to the machine, for example temperature, pressure, or other operational sensor data (which is continuously or frequently collected at regular intervals), maintenance history data associated with operations performed by human technicians (which includes error codes associated with the machine and is intermittently or otherwise infrequently collected compared to the high-frequency data of the sensor(s)), and/or static characteristic data of the machine (such as machine type, model, and/or the like, which is either immutable or relatively static). Continuing this example, such various data inputs may be processed to generate a particular output predicting whether a machine is actively running, in a power-saving state, how fast the machine is running, and/or the like.

By default, machine learning model implementations do not handle different timescale data accurately. In fact, combining different timescale data in a manner that yields accurate results from the model requires specific additional implementations and considerations to ensure that such models remain functioning accurately. Naïve implementation of different timescale data fails to sufficiently maximize the performance of such model(s), leading to models that may function but fail to perform with maximal accuracy, or in some instances even sufficient accuracy for use within a particular domain. For example, default implementations that treat all such portions of the different input data of different timescales equally may fail to maximally derive complex learnings from the different effects of the different timescale data across time. Accordingly, the inventors have identified that custom implementations for processing the different timescale data is appropriate to maximize the performance of a particular model. Existing attempts to address the reduced accuracy of such models when processing different timescale data fail to adequately produce accurate models.

Embodiments of the present disclosure provide for improved processing of different timescale data using an optimal implementation of a particular model, such as a prediction model. Some embodiments process high-frequency data (e.g., associated with a high capture rate) and low-frequency data (e.g., associated with a lower capture rate), and utilize the data to generate a plurality of variants of a prediction model. The prediction model may be trained to predict a particular desired output, for example embodied in output truth source data. The plurality of variants in some embodiments are generated by beginning training of a variant based on the high-frequency data and subsequently introducing the low-frequency data, or data derived therefrom (e.g., embodied as a vector representation of features of the low-frequency data), and/or other timescale data sets (e.g., static data) into the training of the model at different points during such training. For example, such data may be introduced at different layers of a machine learning model, and training may continue for the remainder of the layers based on the combined input after introduction. Upon completion of the training of such variants, the plurality of variants may be processed and compared based on performance of each of such variants, such that an optimal variant may be determined based on the best performing performance data for a particular variant. The optimal variant may subsequently be utilized in subsequent operations to ensure that the model performs optimally as compared to a naïve model implementation and/or even as compared to other variants.

In one example context, an encoder-decoder model is trained to transform sequences of sensor data (e.g., from a continuous glucose monitor and/or other health-related sensor or device), together with healthcare inspection data (e.g., from an electronic medical record including ICD codes for a particular patient and/or optionally static data (e.g., patient demographic or biographical data) into activity sequence(s). The encoder-decoder model may implement a U-net architecture and be trained as described above by introducing particular input data embodying or derived from the inspection data and/or static data at different layers of the encoder-decoder model. The model may employ a fading memory device that weights recent inspection data more heavily than older inspection data, and/or may utilize an attention mechanism that learns which elements of the inspection data are particularly important to the desired data-driven determination (e.g., generation of a predicted activity sequence or other output from the model). The resulting optimal variant in some such embodiments performs best for predicting the activity sequence(s) from the combination of input data with different timescales, including sensor data, inspection data, and static data.

In this regard, it will be appreciated by one having ordinary skill in the art to which this disclosure relates that the improved methodologies for processing different timescale data, particularly in use with machine learning models, provides a myriad of technical improvements to the operation of computer systems and/or other technical fields (e.g., machine learning model operation), and provides a technical solution to many of the technical problems highlighted above. By utilizing embodiments of the present disclosure, the resulting model performs more accurately than simple and/or naïve custom implementations of a model, and/or default implementations of a machine learning model. Additionally or alternatively, some embodiments of the present disclosure facilitate emphasis of particular portions of the various input data sets that are identified as relevant utilizing a particularly defined attention model. Additionally or alternatively still, some embodiments of the present disclosure facilitate learned drop-off of temporally irrelevant data based on the relevant timescales for such data as learned by the model during training. As such, embodiments of the present disclosure provide technical improvements of the operation of machine learning models configured as described in a myriad of manners that each contribute to improving the accuracy of the results produced by such machine learning models. Additionally, by training an optimal variant of a machine learning model in the manner described, different domains and/or use cases may result in optimal variants that have been trained differently (e.g., with introduction of low-frequency data and/or data derived therefrom at different points in the training process). In this regard, embodiments of the present disclosure ensure that each domain of modeling problem results in a model optimally trained specifically for that domain.

“Attention model” may refer to a statistical, algorithmic, and/or machine learning model that generates weight(s) that facilitates emphasis on particular feature(s) of an input data set having a plurality of features.

“Capture rate” with respect to a particular sensor may refer to a time interval between instances of the particular sensor measuring one or more data value(s) by capturing data sample(s) from an environment.

“Code” may refer to data representing or associated with a state, aspect, or interaction with a particular entity with which the code is associated. Non-limiting examples of a code include a medical treatment, diagnosis, cost, reimbursement, associated disease, associated drug, and/or other medical data code associated with a patient, and an error code associated with a machine.

“Code data vector” may refer to a set, array, vector, or other data structure that includes data value(s) corresponding to a particular code. “Code data vector set” may refer to one or more data object(s) including or embodying any number of code data vectors.

“Combined vector” may refer to a set, array, vector, or other data structure that includes a combination of one or more other data vector(s), and which may be associated with attention weight(s) for one or more feature(s) of such vector(s). In one example context the combined vector includes combination of a time-by-code vector and a static vector, and/or multiple time-by-code vectors.

“High-frequency data” may refer to electronically managed data that is captured at a particular faster rate than a secondary rate corresponding to low-frequency data. In some embodiments, high-frequency data includes sensor data captured at a regular and frequent capture rate.

“Low-frequency data” may refer to electronically managed data that is captured at a second, intermittent and/or slower rate than a secondary rate corresponding to high-frequency data. In some embodiments, low-frequency data includes healthcare provider and/or healthcare facility submissions to an electronical medical record in response to a medical encounter.

“Low-frequency encoding model” may refer to at least one algorithmic, statistical, and/or machine learning model that converts data value(s) for any number of parameter(s) represented in one or more portion(s) of low-frequency data to vectorized low frequency data. Non-limiting examples of a low-frequency encoding model include a trained image processing model, a trained text extraction model, and/or a trained language model.

“Missing data value” may refer to a data value for a timestamp that is not present and/or unverified in a timeseries of data values associated with a particular capture rate.

“Multi-head attention layer” may refer to an attention mechanism that combines attention of various portion(s) of input data by performing multiple attention computations in parallel.

“Optimal variant” may refer to a variant of a prediction model that is determined as corresponding to the best performance data of a plurality of variants of the prediction model. In some embodiments, what performance data is determined “best” is based at least in part on a determination that the performance data is greatest, or otherwise satisfies a particular data-driven determination.

“Output truth source data” may refer to at least one data structure that indicates a particular accurate state for a particular timestamp. Portion(s) of output truth source data in some embodiments is/are automatically determined or manually provided via user input.

“Performance data” may refer to electronically managed data representing accuracy of a performance of a model with respect to a particular output truth source data during testing of the model. “Performance data set” may refer to one or more data object(s) including or embodying any number of performance data corresponding to any number of model(s).

“Prediction model” may refer to an algorithmic, statistical, and/or machine learning model that is trained to predict a state or missing data value based on input data.

“Recordation timestamp” may refer to a timestamp at which a portion of low-frequency data was captured, received, and/or otherwise recorded.

“Scaled time differential” may refer to a difference between at least two timestamps that is transformed from an original time scale to a second time scale.

“Sensed timestamp” may refer to a timestamp at which a portion of high-frequency data is captured, received, and/or otherwise recorded.

“State” may refer to electronically managed data representing a particular behavior, attribute, or other attributable data label to a particular entity associated with data being processed. In some embodiments a state is selectable from a universe of candidate states. In one example context, a state may refer to an activity state from one of a “sleeping” state, a “walking” state, a “running” state, and a “stationary awake” state.

“State prediction” may refer to a state associated with a particular entity generated by a prediction model.

“Time differential” may refer to electronically managed data representing the difference in time between a first timestamp and a second timestamp.

“Time transformation function” may refer to a mathematical algorithm or function that generates a representation of one or more data point(s) along a time scale.

“Time-by-code vector” may refer to a vector representing a transformed time vector and a code data vector, where the code data vector is aligned with a particular transformed time vector based on a timestamp.

“Trained language model” may refer to at least one natural language model or other text processing model that extracts particular data value(s) for particular data parameter(s) or other feature(s) from inputted text-parsable or image-parsable data.

“Variant” may refer to an implementation of a prediction model trained with introduction of certain training data at a particular layer of the prediction model.

“Transformed time vector” may refer to a set, array, vector, or other data structure that includes data value(s) transformed from one or more timestamp(s) using a time transformation function.

“Unique code” may refer to electronically managed data indicating a code detected as having at least one instance within low-frequency data. “Unique code set” may refer to one or more data object(s) including or embodying any number of unique code(s) associated with one or more portions of low-frequency data.

“User input” may refer to electronically managed data representing any user engagement, action, or other detected event. Non-limiting examples of a user input include a click, tap, peripheral engagement, key press, gesture, voice command, and/or touch input.

“User-specific vector” may refer to a set, array, vector, or other data structure that includes data value(s) associated with aspect(s) of a user, patient, or other entity. Non-limiting examples of data value(s) representing in a user-specific vector include a vector of user demographics data.

“Vectorized” with respect to particular data portion may refer to a set, array, vector, or other data structure that includes data value(s) for particular data parameter(s) extracted or otherwise identified from the particular data portion. It will be appreciated that different types of data portions may be associated with different data parameter(s).

“Vectorized low frequency data” may refer to a set, array, vector, or other data structure that includes data value(s) of data parameter(s) extracted or otherwise identified from low-frequency data.

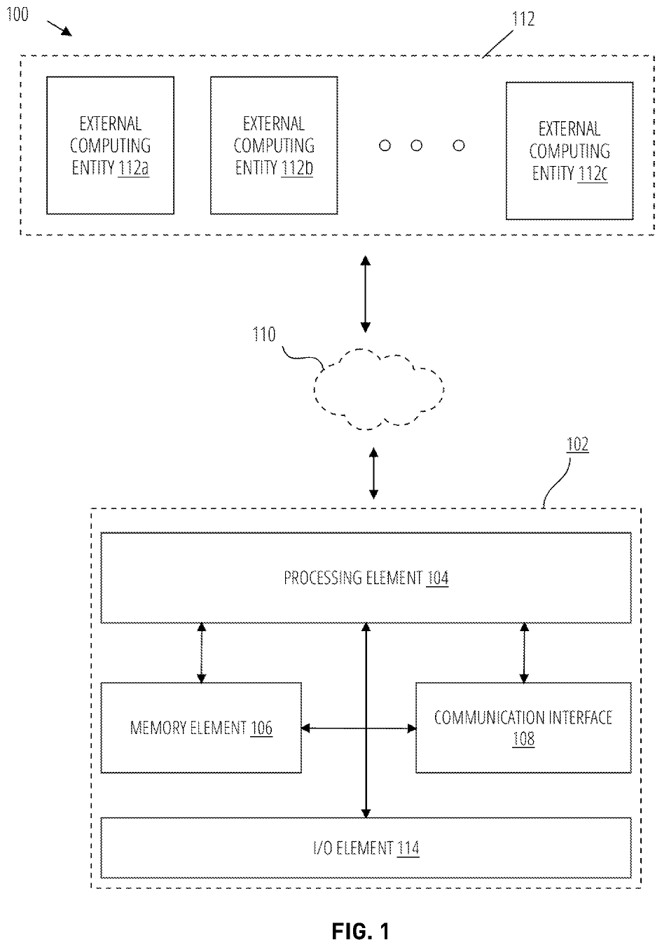

FIG. 1 illustrates an example computing system 100 in accordance with one or more embodiments of the present disclosure. The computing system 100 may include a predictive computing entity 102 and/or one or more external computing entities 112a-c communicatively coupled to the predictive computing entity 102 using one or more wired and/or wireless communication techniques. The predictive computing entity 102 may be specially configured to perform one or more steps/operations of one or more prediction techniques described herein. In some embodiments, the predictive computing entity 102 may include and/or be in association with one or more mobile device(s), desktop computer(s), laptop(s), server(s), cloud computing platform(s), and/or the like. In some example embodiments, the predictive computing entity 102 may be configured to receive and/or transmit one or more data objects from and/or to the external computing entities 112a-c to perform one or more steps/operations of one or more prediction techniques described herein.

The external computing entities 112a-c, for example, may include and/or be associated with one or more devices, sensors, data centers, and/or the like that specially configures at least one model for processing different timescale data. The devices and/or sensors, for example, may be wearable devices, sensors, end user devices, and/or other sources of high-frequency data and/or low-frequency data. The data centers, for example, may be associated with one or more data repositories storing data that may, in some circumstances, be processed to train a particular model for processing different timescale data and/or utilize such data for processing by a specially trained model via the predictive computing entity 102, such as at least one data portion of high-frequency data, low-frequency data, static data, and/or the like. The data centers may include particular data corresponding to a particular entity, for example medical claim data, monitored sensor data, and/or the like, each associated with a particular patient identifier or other device or user identifier. By way of example, the external computing entities 112a-c may be associated with a plurality of entities. A first example external computing entity 112a, for example, may host a registry for the entities. By way of example, in some example embodiments, the entities may include one or more service providers and the external computing entity 112a may host a registry (e.g., the national provider identifier registry, and/or the like) including one or more medical record(s) for patients that have engaged with the service providers. In addition, or alternatively, a second example external computing entity 112b may include one or more claim processing entities that may receive, store, and/or have access to a historical interaction dataset for the entities, claims submission data, and/or the like for a particular patient. In some embodiments, a third example external computing entity 112c may include a host of centralized medical records available for a particular patient. By way of example, in some embodiments, a fourth example computing entity includes a remote storage system of sensor data collected at particular regular interval(s) by one or more sensor(s)

The predictive computing entity 102 may include, or be in communication with, one or more processing elements 104 (also referred to as processors, processing circuitry, digital circuitry, and/or similar terms used herein interchangeably) that communicate with other elements within the predictive computing entity 102 via a bus, for example. As will be understood, the predictive computing entity 102 may be embodied in a number of different ways. The predictive computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the predictive computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like may be used to control certain aspects of the operation of the predictive computing entity 102 with the assistance of the processing element 104.

As indicated, in one embodiment, the predictive computing entity 102 may also include one or more communication interfaces 108 for communicating with various computing entities such as the external computing entities 112a-c, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

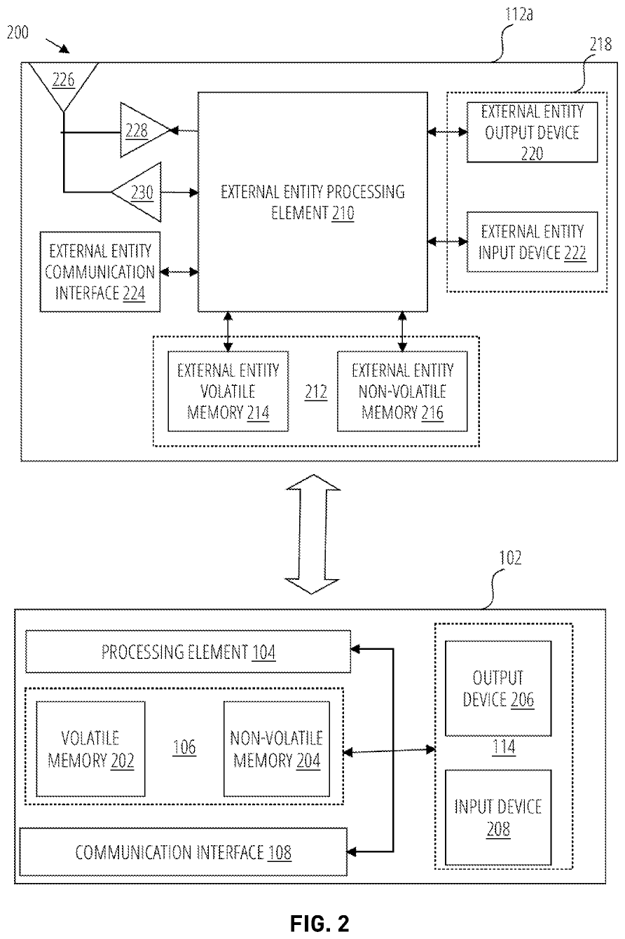

FIG. 2 is a schematic diagram showing a system computing architecture 200 in accordance with some embodiments discussed herein. In some embodiments, the system computing architecture 200 may include the predictive computing entity 102 and/or the external computing entity 112a of the computing system 100. The predictive computing entity 102 and/or the external computing entity 112a may include a computing apparatus, a computing device, and/or any form of computing entity configured to execute instructions stored on a computer-readable storage medium to perform certain steps or operations.

The predictive computing entity 102 may include a processing element 104, a memory element 106, a communication interface 108, and/or one or more I/O elements 114 that communicate within the predictive computing entity 102 via internal communication circuitry such as a communication bus, and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

The memory element 106 may include non-volatile memory 204 (also referred to as non-volatile storage, memory, memory storage, memory circuitry and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the predictive computing entity 102 to perform one or more step/operations described herein.

Implementations of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as in a particular directory, folder, or library. Software components may be static (e.g., pre-established, or fixed) or dynamic (e.g., created, or modified at the time of execution).

The predictive computing entity 102 may be embodied by a computer program product include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The predictive computing entity 102 may include one or more I/O elements 114. The I/O elements 114 may include one or more output devices 206 and/or one or more input devices 208 for providing and/or receiving information with a user, respectively. The output devices 206 may include one or more sensory output devices such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices such as one or more tactile input devices (e.g., touch sensitive displays, push buttons, and/or the like), one or more audio input devices (e.g., microphones, and/or the like), and/or the like.

In addition, or alternatively, the predictive computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry such as a communication bus, and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include at least one external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above with regard to the predictive computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something to within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### Example Framework

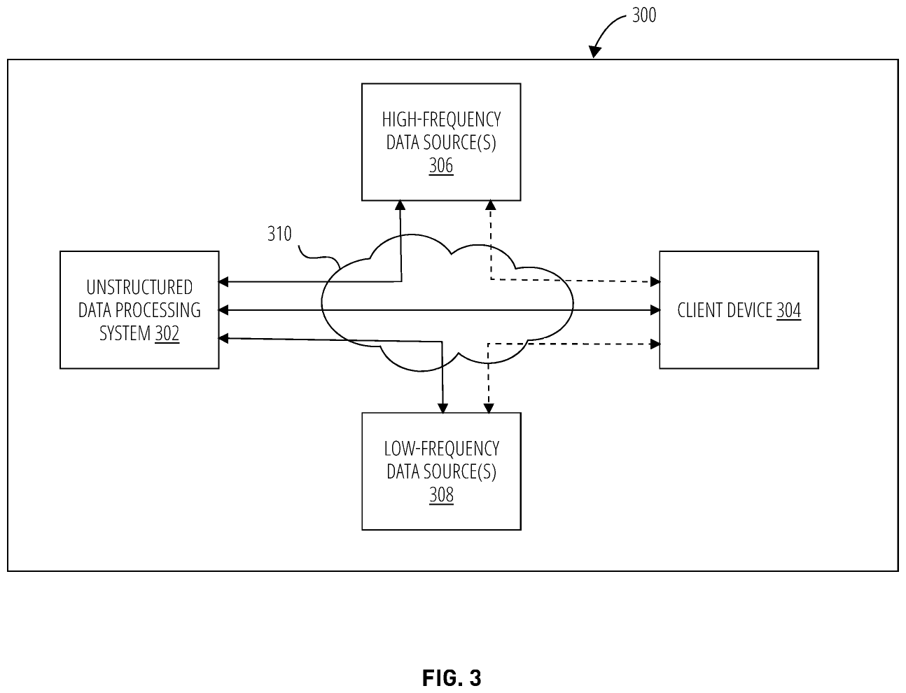

FIG. 3 illustrates a system diagram of an example system in accordance with at least one example embodiment of the present disclosure. Specifically, FIG. 3 illustrates an example framework 300. The example framework 300 includes at least unstructured data processing system 302, client device 304, high-frequency data source(s) 306, and low-frequency data source(s) 308. In some embodiments, the framework 300 includes a communications network 310 that enables transmission of data between one or more of the subsystem(s) and/or device(s) of the framework 300. For example, in some embodiments the communications network 310 facilitates communication between the unstructured data processing system 302 and one or more of the high-frequency data source(s) 306, low-frequency data source(s) 308, and/or client device 304. Additionally or alternatively, in some embodiments, the communications network 310 or another communications network (not depicted) facilitate communication between the client device 304 and one or more of the high-frequency data source(s) 306 and low-frequency data source(s) 308.

The high-frequency data source(s) 306 includes one or more computer(s) embodied in hardware, software, firmware, and/or a combination thereof. In some embodiments, the high-frequency data source(s) 306 includes one or more sensor(s), monitoring system(s), wearable(s), and/or the like that are configured to perform the functionality described herein. For example, in some embodiments the high-frequency data source(s) 306 includes one or more computing device(s), sensor(s), and/or the like that generates, collects, and/or otherwise receives high-frequency data associated with an entity or a plurality of entities. Each source of the high-frequency data source(s) 306 may generate, collect, and/or otherwise receive high-frequency data at a particular regular interval, for example one every X seconds, minutes, and/or the like. The capture rate of the high-frequency data source(s) 306 may be faster than a particular threshold, or faster than an alternative capture rate for corresponding low-frequency data to be processed as described herein. Each portion of data may be stored individually, or in some embodiments the high-frequency data source(s) 306 aggregate at least a portion of the data to generate a particular high-frequency data value for a particular timestamp (e.g., by averaging or otherwise aggregating collected data values gathered every 5 seconds over a 5-minute time interval, for example). In some such embodiments, some or all of the high-frequency data source(s) 306 are disposed with sufficient proximity to a particular entity (e.g., a patient or other user, a monitored machine or industrial system, a monitored computing system, and/or the like) to be monitored by the high-frequency data source(s) 306, such that the high-frequency data associated with the entity may be collected. In some embodiments, the high-frequency data source(s) 306 includes one or more backend system(s) that facilitate operation of at least one corresponding front-end sensor. Non-limiting examples of high-frequency data source(s) 306 include a continuous glucose monitor, a blood pressure monitor, a wearable activity tracker, a thermometer, a pressure sensor, an ECG, a force sensor, an airflow sensor, and/or the like.

The low-frequency data source(s) 308 includes one or more computer(s) embodied in hardware, software, firmware, and/or a combination thereof. In some embodiments, the low-frequency data source(s) 308 includes one or more data repositories, data entry system(s), data warehouse(s), historical record management system(s), and/or the like, that maintains or otherwise receives low-frequency data associated with an entity or plurality of entities. In some embodiments the low-frequency data source(s) 308 includes one or more application server(s), database server(s), enterprise computing terminal(s), cloud computer(s), and/or the like. In some embodiments, the low-frequency data source(s) 308 includes or embodies one or more backend system(s) that are communicable over one or more network(s), such as via the Internet or via an intranet associated with monitoring a particular entity or entities.

Each source of the low-frequency data source(s) 308 may generate, collect, and/or otherwise receive low-frequency data at an intermittent or otherwise spaced frequency (e.g., several days, weeks, or months apart, or longer), which may be regular (e.g., collected weekly during a maintenance period or weekly check-in) or irregularly collected (e.g., only when a maintenance call is submitted or when a patient seeks medical care). In this regard, the capture rate of the low-frequency data source(s) 308 may be slower than the capture rate of corresponding high-frequency data, for example captured via the high-frequency data source(s) 306 as described herein. In some embodiments, the low-frequency data source(s) 308 includes code(s) associated with a particular entity or plurality of entities, and a timestamp corresponding to such codes. For example, in some embodiments, the low-frequency data source(s) 308 includes one or more data repositories storing electronic medical records for one or more patient(s) engaging with one or more healthcare provider(s) that includes medical code(s) associated with such healthcare encounters, one or more maintenance log(s) for machine(s) interacted with by a maintenance user to address one or more particular error code(s), and/or the like.

The unstructured data processing system 302 includes one or more computer(s) embodied in hardware, software, firmware, and/or a combination thereof. In some embodiments, the unstructured data processing system 302 includes one or more computer(s) that train one or more variants of a particular model for processing different timescale data and determines an optimal variant for subsequent use, and/or utilizes an optimal variant for processing particular data of different timescales. In some embodiments, the unstructured data processing system 302 includes front-facing user terminal(s), system(s), and/or the like that is engageable by an end user to interact with and/or view data to be processed and/or model(s) trained by or otherwise accessible to the unstructured data processing system 302. In some embodiments, the unstructured data processing system 302 includes or is communicable with a subsystem, or separate system, that performs the training of the model variants in the manner described herein.

In some embodiments, the unstructured data processing system 302 is configured to receive high-frequency data, for example from a high-frequency data source(s) 306 and/or one or more repository that stores high-frequency data and is included in or otherwise accessible to the unstructured data processing system 302 that stores. Additionally or alternatively, in some embodiments, the unstructured data processing system 302 is configured to receive low-frequency data, for example from low-frequency data source(s) 308 and/or one or more repository that stores low-frequency data and is included in or otherwise accessible to the unstructured data processing system 302. Additionally or alternatively, in some embodiments, the unstructured data processing system 302 is configured to receive output truth source data, for example from one or more repository included in or otherwise accessible to the unstructured data processing system 302. Additionally or alternatively, in some embodiments, the unstructured data processing system 302 is configured to generate vectorized low frequency data and/or vectorized high-frequency data. Additionally or alternatively, in some embodiments, the unstructured data processing system 302 is configured to generate a plurality of variants of a prediction model that each product the output truth source data, wherein each variant introduces the vectorized low frequency data at a different point during the training. Additionally or alternatively, in some embodiments, the unstructured data processing system 302 is configured to determine and/or select an optimal variant from the plurality of variants, and/or store the optimal variant for subsequent use. Additionally or alternatively, regardless of whether the unstructured data processing system 302 is configured to perform the training itself, in some embodiments the unstructured data processing system 302 is configured to receive high-frequency data and/or low-frequency data, and process such data, and/or vectorized representations thereof, utilizing an optimal variant of a plurality of variants stored to the unstructured data processing system 302. Additionally or alternatively, in some such embodiments, the unstructured data processing system 302 is configured to store and/or transmit resulting data outputted by the optimal variant of the processing model. For example, in some embodiments, the resulting data represents a state prediction, missing data value, and/or other data output that is utilized in one or more subsequent process.

The client device 304 includes one or more computer(s) embodied in hardware, software, firmware, and/or a combination thereof. In some embodiments, the client device 304 includes one or more user device(s) or other front-end device(s) that enable communication and/or interaction with the functionality of the unstructured data processing system 302. In some embodiments, the client device 304 includes a smartphone, a tablet, a personal computer, a laptop, a smart device, an enterprise terminal, and/or the like. In some embodiments, the client device 304 includes at least one computer associated with an entity being monitored, and/or a user performing monitoring of the entity.

In some embodiments, the client device 304 includes or embodies one or more other subsystems of the framework 300. For example, in some embodiments, the client device 304 includes or otherwise embodies the low-frequency data source(s) 308, for example where the client device 304 stores, receives, and/or otherwise maintains low-frequency data. Additionally or alternatively, in some embodiments, the client device 304 includes or otherwise embodies the high-frequency data source(s) 306, for example where the client device 304 includes one or more sensor(s) used for monitoring an entity integrated into the client device, and/or is paired with one or more such sensor(s) to receive and/or maintain the high-frequency data from such sensor(s). For example, in some embodiments, the client device 304 pairs with a wearable sensor, continuous monitoring device, and/or the like, included in the high-frequency data source(s) 306 and that relays high-frequency data to the client device 304 for processing.

The communications network 310 is configurable to be embodied in any of a myriad of network configurations. In some embodiments, the communications network 310 embodies a public network (e.g., the Internet). In some embodiments, the communications network 310 embodies a private network (e.g., an internal, localized, or closed-off network between particular devices). In some other embodiments, the communications network 310 embodies a hybrid network (e.g., a network enabling internal communication between particular connected devices and external communication with other devices). The communications network 310 in some embodiments includes one or more base station(s), relay(s), router(s), switch(es), cell tower(s), communications cable(s) and/or associated routing station(s), and/or the like. In some embodiments, the communications network 310 includes one or more computing device(s) controlled by individual entities (e.g., an entity-owner router and/or modem) and/or one or more external utility devices (e.g., Internet service provider communication tower(s) and/or other device(s)).

The communications network 310 may operate utilizing one or more networking communication protocol(s). For example, in some embodiments, the communications network 310 is accessible at least in part utilizing Wi-Fi, Bluetooth, NFC, ZigBee, and/or the like. It should be appreciated that in some embodiments, the communications network 310 includes one or more sub-network(s) that includes one or more different device(s), utilizes different protocol(s), and/or the like. For example, in some embodiments, the client device 304 and the unstructured data processing system 302 communicate at least in part a Wi-Fi network, for example over the Internet, and the client device 304 communicates with the high-frequency data source(s) 306 and/or 308 via a short-range communication network, for example Bluetooth.

The computing devices of the framework 300 may each communicate in whole or in part over a portion of one or more communication network(s), such as the communications network 310. For example, each of the components of the framework 300 may be communicatively coupled to transmit data to and/or receive data from one another over the same and/or different wireless or wired networks embodying the communications network 310. Non-limiting examples of network configuration(s) for the communications network 310 include, without limitation, a wired or wireless Personal Area Network (PAN), Local Area Network (LAN), Metropolitan Area Network (MAN), Wide Area Network (WAN), and/or the like. Additionally, while FIG. 3 illustrate certain system entities as separate, standalone entities communicating over the communications network(s), the various embodiments are not limited to this particular architecture. In other embodiments, one or more computing entities share one or more components, hardware, and/or the like, or otherwise are embodied by a single computing device such that connection(s) between the computing entities are altered and/or rendered unnecessary. Alternatively or additionally still, in some embodiments the communications network 310 enables communication to one or more other computing device(s) not depicted, for example client device(s) for accessing functionality of any of the subsystems therein via native and/or web-based application(s), and/or the like.

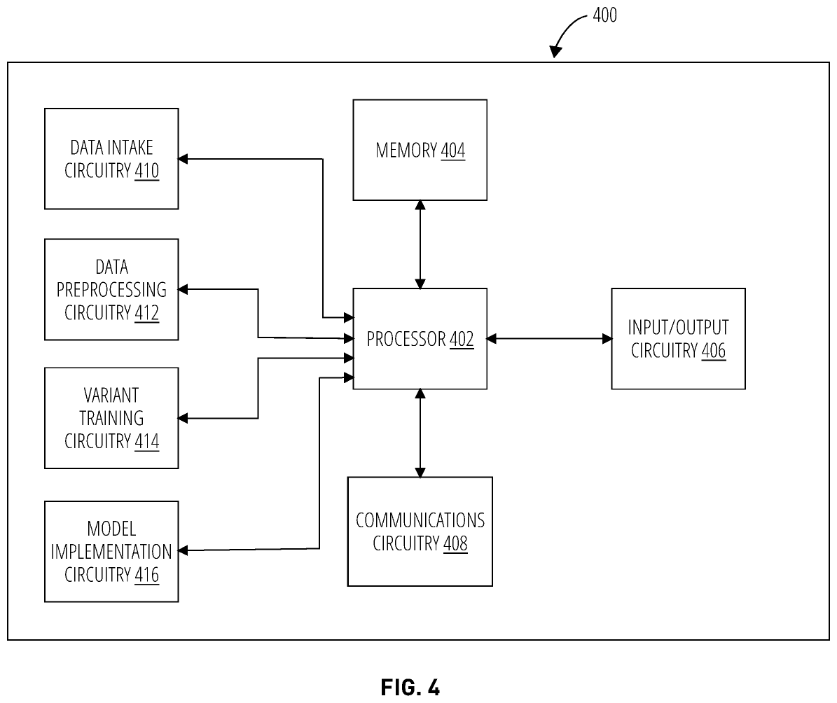

FIG. 4 illustrates a block diagram of an example apparatus that may be specially configured in accordance with at least one example embodiment of the present disclosure. Specifically, FIG. 4 illustrates an example unstructured data processing apparatus 400 (apparatus 400) specially configured in accordance with at least one example embodiment of the present disclosure. In some embodiments, the unstructured data processing system 302, and/or a portion thereof, is embodied by one or more system(s), device(s), and/or the like, such as the apparatus 400 as depicted and described in FIG. 4. The apparatus 400 includes processor 402, memory 404, input/output circuitry 406, communications circuitry 408, data intake circuitry 410, data preprocessing circuitry 412, variant training circuitry 414, and model implementation circuitry 416. In some embodiments, the apparatus 400 is configured, using one or more of the sets of circuitry, including processor 402, memory 404, input/output circuitry 406, communications circuitry 408, data intake circuitry 410, data preprocessing circuitry 412, variant training circuitry 414, and/or model implementation circuitry 416, to execute and perform one or more of the operations described herein.

In general, the terms computing entity (or entity in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the apparatus 400 embodies a particular, specially configured computing entity transformed to enable the specific operations described herein and provide the specific advantages associated therewith, as described herein.

Although components of the apparatus 400 are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the apparatus 400 provide or supplement the functionality of another particular set of circuitry. For example, the processor 402 in some embodiments provides processing functionality to any of the sets of circuitry, the memory 404 provides storage functionality to any of the sets of circuitry, the communications circuitry 408 provides network interface functionality to any of the sets of circuitry, and/or the like.

In some embodiments, the processor 402 (and/or co-processor or any other processing circuitry assisting or otherwise associated with the processor) is/are in communication with the memory 404 via a bus for passing information among components of the apparatus 400. In some embodiments, for example, the memory 404 is non-transitory and may include, for example, one or more volatile and/or non-volatile memories. In other words, for example, the memory 404 in some embodiments includes or embodies an electronic storage device (e.g., a computer readable storage medium). In some embodiments, the memory 404 is configured to store information, data, content, applications, instructions, or the like, for enabling the apparatus 400 to carry out various functions in accordance with example embodiments of the present disclosure.

The processor 402 may be embodied in a number of different ways. For example, in some example embodiments, the processor 402 includes one or more processing devices configured to perform independently. Additionally or alternatively, in some embodiments, the processor 402 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 400, and/or one or more remote or “cloud” processor(s) external to the apparatus 400.

In an example embodiment, the processor 402 is configured to execute instructions stored in the memory 404 or otherwise accessible to the processor. Alternatively or additionally, the processor 402 in some embodiments is configured to execute hard-coded functionality. As such, whether configured by hardware or software methods, or by a combination thereof, the processor 402 represents an entity (e.g., physically embodied in circuitry) capable of performing operations according to an embodiment of the present disclosure while configured accordingly. Alternatively or additionally, as another example in some example embodiments, when the processor 402 is embodied as an executor of software instructions, the instructions specifically configure the processor 402 to perform the algorithms embodied in the specific operations described herein when such instructions are executed. In some embodiments, the processor 402 includes or is embodied by a CPU, microprocessor, and/or the like that executes computer-coded instructions, for example stored via the non-transitory memory 404.

In some example embodiments, the processor 402 is configured to perform various operations associated with processing different timescale data, for example high-frequency data and low-frequency data, and/or optionally static data. In this regard, in some embodiments the processor 202 enables training of an optimal variant of a model and/or use of an optimal variant for producing output result data from input data of multiple different timescales. In some embodiments, the processor 402 includes hardware, software, firmware, and/or any combination thereof, that receives input data of multiple timescales for processing. Additionally or alternatively, in some embodiments, the processor 402 includes hardware, software, firmware, and/or any combination thereof, that receives an output truth source data representing trusted output results. Additionally or alternatively, in some embodiments, the processor 402 includes hardware, software, firmware, and/or any combination thereof, that trains a plurality of variants of a particular model based on the input data of different timescales, for example by beginning training of each variant utilizing particular data of a first timescale and introducing the input data of a different timescale at a different point in the training for each different variant. Additionally or alternatively, in some embodiments, the processor 402 includes hardware, software, firmware, and/or any combination thereof, that determines and/or selects an optimal variant of the plurality of variants, and/or stores at least the optimal variant for use. Additionally or alternatively, in some embodiments, the processor 402 includes hardware, software, firmware, and/or any combination thereof, that processes inputted data of different timescales utilizing an optimal variant of a particular model, for example a prediction model, to generate output results data based on the inputted data.

In some embodiments, the apparatus 400 includes input/output circuitry 406 that provides output to the user and, in some embodiments, to receive an indication of a user input. In some embodiments, the input/output circuitry 406 is in communication with the processor 402 to provide such functionality. The input/output circuitry 406 may comprise one or more user interface(s) and in some embodiments includes a display that comprises the interface(s) rendered as a web user interface, an application user interface, a user device, a backend system, or the like. In some embodiments, the input/output circuitry 406 also includes a keyboard, a mouse, a joystick, a touch screen, touch areas, soft keys a microphone, a speaker, or other input/output mechanisms. The processor 402 and/or input/output circuitry 406 comprising the processor may be configured to control one or more functions of one or more user interface elements through computer program instructions (e.g., software and/or firmware) stored on a memory accessible to the processor (e.g., memory 404, and/or the like). In some embodiments, the input/output circuitry 406 includes or utilizes a user-facing application to provide input/output functionality to a client device and/or other display associated with a user. In some embodiments, the input/output circuitry 406 includes hardware, software, firmware, and/or a combination thereof, that facilitates simultaneously display of particular data via a plurality of different devices.

In some embodiments, the apparatus 400 includes communications circuitry 408. The communications circuitry 408 includes any means such as a device or circuitry embodied in either hardware or a combination of hardware and software that is configured to receive and/or transmit data from/to a network and/or any other device, circuitry, or module in communication with the apparatus 400. In this regard, in some embodiments the communications circuitry 408 includes, for example, a network interface for enabling communications with a wired or wireless communications network. Additionally or alternatively in some embodiments, the communications circuitry 408 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 408 includes circuitry for interacting with the antenna(s) and/or other hardware or software to cause transmission of signals via the antenna(s) or to handle receipt of signals received via the antenna(s). In some embodiments, the communications circuitry 408 enables transmission to and/or receipt of data from a client device, sensor, data repository, and/or other external computing device in communication with the apparatus 200.

In some embodiments, the apparatus 400 includes data intake circuitry 410. The data intake circuitry 410 supports receiving of data for training and/or processing via a particular model, for example a prediction model. For example, in some embodiments, the data intake circuitry 410 includes hardware, software, firmware, and/or any combination thereof, that receives data of a plurality of different timescales, including high-frequency data, low-frequency data, and/or optionally static data, and/or the like. In some such embodiments, the data intake circuitry 410 includes hardware, software, firmware, and/or any combination thereof, that retrieves at least a portion of data from at least one repository maintained by and/or otherwise accessible to the apparatus 400. Additionally or alternatively, in some embodiments, the data intake circuitry 410 includes hardware, software, firmware, and/or any combination thereof, that operates for collection of one or more data portion(s) for processing, for example sensor(s) that collect high-frequency data. Additionally or alternatively, in some embodiments, the data intake circuitry 410 includes hardware, software, firmware, and/or any combination thereof, that receives data input(s) embodying particular types of data for processing, for example data inputs representing low-frequency data associated with a monitored entity. Additionally or alternatively, in some embodiments, the data intake circuitry 410 includes hardware, software, firmware, and/or any combination thereof, that receives output truth source data, for example that corresponds to a particular entity for which multiple timescale data is processed. In some embodiments, the data intake circuitry 410 includes a separate processor, specially configured field programmable gate array (FPGA), or a specially programmed application specific integrated circuit (ASIC).

In some embodiments, the apparatus 400 includes data preprocessing circuitry 412. The data preprocessing circuitry 412 supports functionality associated with converting raw data inputs to representations processable by one or more model(s). For example, in some embodiments, the data preprocessing circuitry 412 includes hardware, software, firmware, and/or any combination thereof, that generates vectorized low frequency data based on low-frequency data. Additionally or alternatively, in some embodiments, the data preprocessing circuitry 412 includes hardware, software, firmware, and/or any combination thereof, that generates vectorized high-frequency data based on high-frequency data. Additionally or alternatively, in some embodiments, the data preprocessing circuitry 412 includes hardware, software, firmware, and/or any combination thereof, that generates vectorized static data based on static data associated with a particular entity. Additionally or alternatively, in some embodiments, the data preprocessing circuitry 412 includes hardware, software, firmware, and/or any combination thereof, that converts low-frequency data to vectorized low frequency data busing a low-frequency encoding model, for example that identifies a unique code set including any number of unique codes, generates a code data vector set based on each unique code, generating a set of time-by-code vectors based on each instance of a unique code, and generates a combined vector by at least applying the set of time-by-code vectors to an attention model. Additionally or alternatively, in some embodiments, the data preprocessing circuitry 412 includes hardware, software, firmware, and/or any combination thereof, that generates a scaled time differential corresponding to a particular portion of input data, for example a particular portion of high-frequency data and/or low-frequency data, based on a time transformation function. Additionally or alternatively, in some embodiments, the data preprocessing circuitry 412 includes hardware, software, firmware, and/or any combination thereof, that otherwise performs one or more pre-processing algorithm(s) on input data to configure the input data for processing by a prediction model. In some embodiments, the data preprocessing circuitry 412 includes a separate processor, specially configured field programmable gate array (FPGA), or a specially programmed application specific integrated circuit (ASIC).

In some embodiments, the apparatus 400 includes variant training circuitry 414. The variant training circuitry 414 supports functionality associated with training a plurality of variants of a particular model based on multiple timescale data. For example, in some embodiments, the variant training circuitry 414 includes hardware, software, firmware, and/or a combination thereof, that begins training of a plurality of variants of a particular model based on data of a first timescale, such as high-frequency data. Additionally or alternatively, in some embodiments, the variant training circuitry 414 includes hardware, software, firmware, and/or any combination thereof, that introduces one or more other input data portion(s) of different timescale data, such as a second portion of input data including or based on low-frequency data and/or static data, at different points in training each variant of the model. Additionally or alternatively, in some embodiments, the variant training circuitry 414 includes hardware, software, firmware, and/or any combination thereof, that completes training of each variant upon introduction of the different input data portions at different points in the training, for example at different layers for different variants of the model. Additionally or alternatively, in some embodiments, the variant training circuitry 414 includes hardware, software, firmware, and/or any combination thereof, that determines performance data for each variant of a model. Additionally or alternatively, in some embodiments, the variant training circuitry 414 includes hardware, software, firmware, and/or any combination thereof, that determines and/or selects an optimal variant from a plurality of trained variants, for example based on the performance data corresponding to each variant. Additionally or alternatively, in some embodiments, the variant training circuitry 414 includes hardware, software, firmware, and/or any combination thereof, that stores an optimal variant for subsequent use. In some embodiments, the variant training circuitry 414 includes a separate processor, specially configured field programmable gate array (FPGA), or a specially programmed application specific integrated circuit (ASIC).

In some embodiments, the apparatus 400 includes model implementation circuitry 416. The model implementation circuitry 416 supports functionality associated with utilizing a particular implementation of a model, for example an optimal variant, to process input data of different timescales to generate particular output data. For example, in some embodiments, the model implementation circuitry 416 includes hardware, software, firmware, and/or any combination thereof, that retrieves a stored optimal variant of a model, such as a prediction model, for use in processing subsequently received input data of different timescales. Additionally or alternatively, in some embodiments, the model implementation circuitry 416 includes hardware, software, firmware, and/or any combination thereof, that inputs subsequently received input data of different timescales, for example subsequently received high-frequency data, low-frequency data, static data, and/or the like, to the optimal variant for processing. Additionally or alternatively, in some embodiments, the model implementation circuitry 416 includes hardware, software, firmware, and/or any combination thereof, that generates a state prediction utilizing the optimal variant of a model, for example embodied by or based on the output data resulting from use of the optimal variant. Additionally or alternatively, in some embodiments, the model implementation circuitry 416 includes hardware, software, firmware, and/or any combination thereof, that generates a missing data value utilizing the optimal variant of a model, for example embodied by or based on the output data resulting from use of the optimal variant. In some embodiments, the model implementation circuitry 416 includes a separate processor, specially configured field programmable gate array (FPGA), or a specially programmed application specific integrated circuit (ASIC).

Additionally or alternatively, in some embodiments, two or more of the sets of circuitries 402-416 are combinable. Alternatively or additionally, in some embodiments, one or more of the sets of circuitry perform some or all of the functionality described associated with another component. For example, in some embodiments, two or more of the sets of circuitry 402-416 are combined into a single module embodied in hardware, software, firmware, and/or a combination thereof. Similarly, in some embodiments, one or more of the sets of circuitry, for example the data intake circuitry 410, data preprocessing circuitry 412, variant training circuitry 414, and/or model implementation circuitry 416, is/are combined with the processor 402, such that the processor 402 performs one or more of the operations described above with respect to each of these sets of circuitry 410-416.

### Example Data Flows and Architectures of the Disclosure

Having described example systems and apparatuses in accordance with the disclosure, example data flows and architectures will now be discussed. In some embodiments, on or more system(s) maintain one or more computing environment(s) in accordance with the data architecture(s) as depicted and described. For example, in some embodiments the unstructured data processing system 302 embodied by the apparatus 400 maintains one or more software environment(s) (e.g. via executed software application(s) on the apparatus 400) that maintain data in accordance with the example data architecture(s) as depicted and described. Additionally or alternatively, in some embodiments, the apparatus 400 performs the data flow(s) within the maintained computing environment(s). In this regard, it will be appreciated that embodiments of the present disclosure may generate, maintain, and/or manipulate the data as depicted and described with respect to such environment(s).

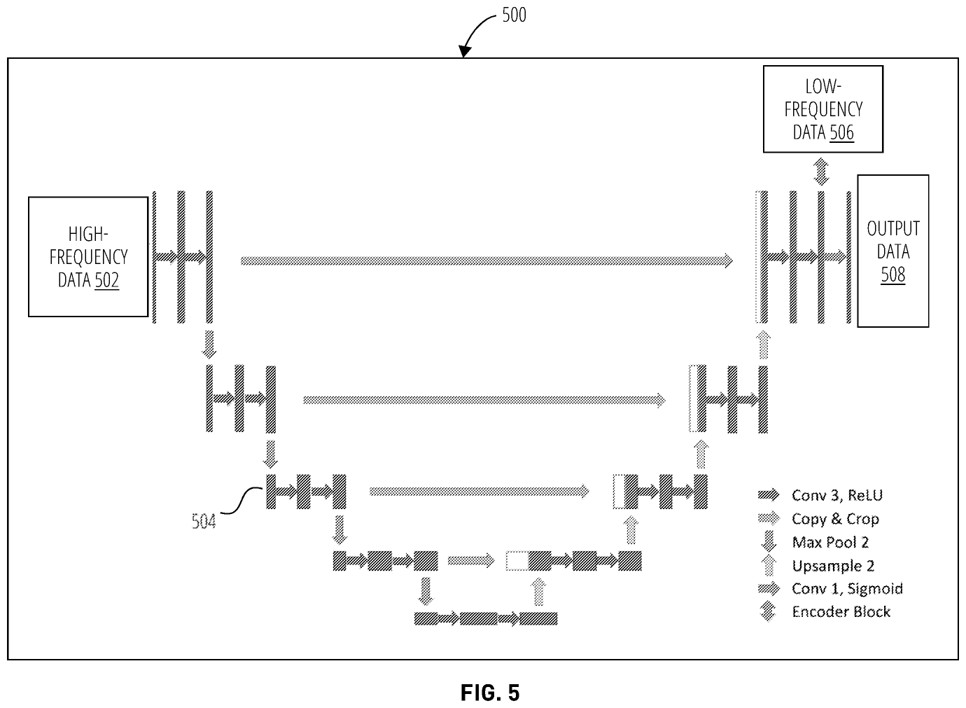

FIG. 5 illustrates an example improved multi-layer prediction model in accordance with at least one example embodiment of the present disclosure. Specifically, FIG. 5 depicts an example variant 500 of an example prediction model, for example where the variant 500 embodies an optimal variant of the particular prediction model. The example prediction model is embodied by a U-net architecture encoder-decoder model having the layers 504, where such layers 504 include convolutional layers, convolutional ReLU layers, max pool layers, copying layers, and up-convolutional (deconvolutional) layers. It will be appreciated that in other embodiments, other architecture(s) may be utilized, for example half-U-net architectures, modified U-net architectures, and/or non-U-net architectures. Additionally, it will be appreciated that the depicted variant is only one example variant of the depicted prediction model, and that one or more other variant(s) in some embodiments may be similarly trained in parallel or in series with the depicted variant 500 as depicted and described herein.

In some embodiments, the variant 500 embodies a prediction model utilized for a particular machine learning task. For example, in some embodiments, the prediction model is trained to generate output data representing a sequence of predictions (e.g., predicted activity states, for example) based at least in part on particular high-frequency data and particular low-frequency data. In some embodiments, the apparatus 200 maintains the variant 500 as the prediction model utilized for performing such prediction(s). In this regard, in some such embodiments, the apparatus 200 is configured for receiving high-frequency data associated with a first capture rate and low-frequency data associated with a second capture rate. Additionally, in some such embodiments the apparatus 200 is configured for generating vectorized low frequency data by converting the low-frequency data using a low-frequency encoding model, as described further herein. Additionally, in some such embodiments the apparatus 200 is configured for processing, utilizing a prediction model such as the prediction model 500, the high-frequency data and the vectorized low-frequency data to generate output data embodying results of the particular prediction task for which the prediction model 500 is trained.

As illustrated, the variant 500 begins at a first layer (left-most layer as depicted). At this layer, the variant 500 begins processing based on the high-frequency data 502. In some embodiments, the high-frequency data 502 is fed directly into the variant 500, In other embodiments, the high-frequency data 502 is pre-processed to prepare .such data for processing by the prediction model. For example, in some embodiments the high-frequency data 502 is vectorized to produce vectorized high-frequency data, for example utilizing one or more encoding model, where the vectorized high-frequency data is subsequently fed into the variant 500 of the prediction model for processing.

In some embodiments, the high-frequency data 502 includes data portion(s) captured by a particular sensor. For example, each data portion may include a data value for a particular data parameter captured by a sensor (e.g., blood pressure, glucose, and/or the like). Additionally or alternatively, in some embodiments, each portion of high-frequency data 502 includes or otherwise corresponds to a sensed timestamp representing a time at which the data value was captured by the sensor.

The high-frequency data 502 may be processed for different purposes based at least in part upon whether the variant 500 is being trained or utilized in production, for example, in some embodiments the high-frequency data 502 includes training high-frequency data in a circumstance where the variant 500 is being trained. The training high-frequency data in some embodiments includes historically collected high-frequency data, for example where such data corresponds to a particular known or otherwise determinable output data that is utilized for learning trends, data patterns, and/or the like. Additionally or alternatively, in some embodiments, the high-frequency data 502 includes training high-frequency data that is collected from one or more sensor(s) or other input source(s) in real-time or near-real-time for training. In other contexts, for example during use of the variant 500 subsequent to training, the high-frequency data 502 includes newly captured or previously-captured-and-stored high-frequency data associated with a particular entity for use in generating unknown output data.

As illustrated, the variant 500 processes the original input data (e.g., the high-frequency data 502) via one or more layers of the layers 504. Specifically, the variant 500 processes the original input data until a particular layer is reached for introduction of one or more subsequent portion(s) of data. As illustrated, for example, the variant 500 processes the high-frequency data 502 until the second-to-last layer of the layers 504 is reached. In the variant 500, a second portion of data is inputted to the prediction model at the second-to-last layer of the layers 504, for example for introduction of low-frequency data 506 and/or vectorized low frequency data based on the layers 504. It will be appreciated that in other contexts, additional and/or alternative data inputs may similarly be inputted at this layer, for example static data associated with a particular entity and/or otherwise corresponding to the high-frequency data 502 and/or low-frequency data 506.

It will be appreciated that other variants may introduce the additional input data, for example the low-frequency data 506 and/or vectorized representation thereof, at another layer of the prediction model. For example, another variant of the prediction model may introduce the additional input data at the first layer of the prediction model together with the high-frequency data 502. Additionally or alternatively, yet another variant of the prediction model may introduce the additional input data at a second layer of the prediction model, a third layer of the prediction model, a halfway-point layer of the prediction model, a final layer of the prediction model, an/.or the like. In some embodiments, the variant 500 is determine as the optimal variant during training of such variants as depicted and described herein. For example, some embodiments determine an optimal variant based on performance data determined for each variant during training, such as where the variant 500 is determined to correspond to the optimal performance data based on one or more metrics (e.g., accuracy, efficiency, and/or the like).

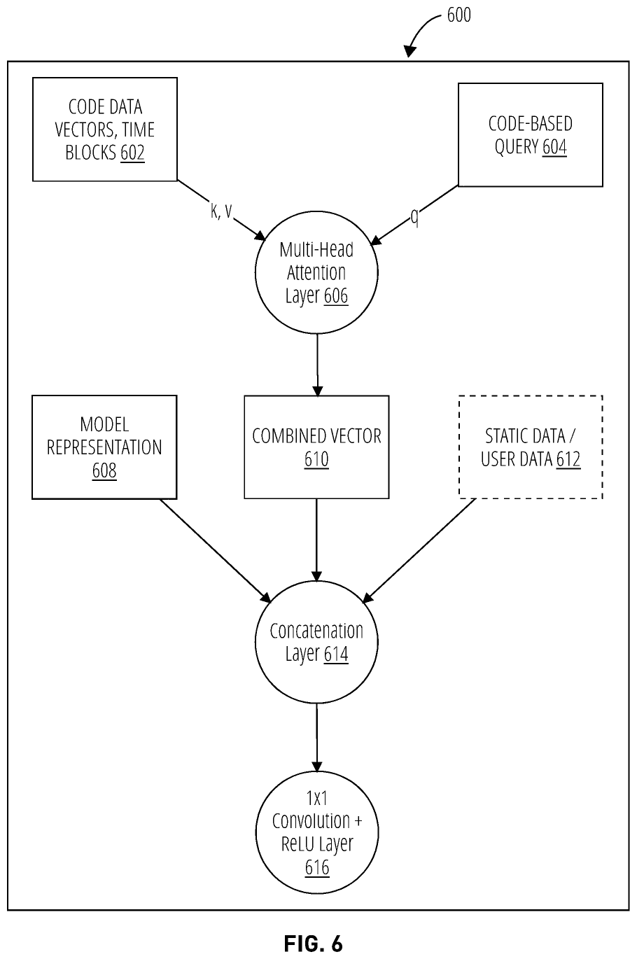

As illustrated, the low-frequency data 506 is processed for inclusion into the prediction model for processing. Specifically, the low-frequency data 506 is processed or generated by a particular encoding model, such that the resulting data outputted by the encoding model is introduced to the variant 500 of the prediction model at the second to last layer. In some embodiments, the encoding model processes the low-frequency data 506 into a vector of data features that is processable by the layers 504 of the prediction model. For example, in some embodiments the encoding model generates vectorized low-frequency data based on the low-frequency data 506 and inputs the vectorized low frequency data into the variant 500. Additionally or alternatively, in some embodiments, the encoding model applies attention to particular features, introduces or extracts particular features, and/or otherwise preprocesses the low-frequency data 506 before introduction to the variant of the prediction model. In some embodiments, the encoding model includes one or more algorithmic, statistical, and/or machine learning model(s) that produce a vector of data based on codes and/or other data extracted from the low-frequency data, for example medical codes extracted from a patient's electronic medical records, such as ICD2VEC or similar implementations. Additionally or alternatively, in some embodiments, the encoding model introduces or otherwise processes additional and/or alternative input data portion(s) in with the low-frequency data 506, for example static data (e.g., user-specific data and/or model-specific data, and/or the like) for introduction as input to the variant of the prediction model. Non-limiting examples of encoding model are further described herein, for example with respect to FIG. 6.

In some embodiments, the introduced data outputted from the encoding model is processed as input data portion(s) of the low-frequency data 506 by the variant 500 of the prediction model. For example, in some embodiments, the vectorized low frequency data and/or other data output by the encoding model 308 is concatenated with the existing input data, for example the high-frequency data 502 or representation(s) thereof. In this regard, the variant 500 may continue to process the input data (included newly introduced vectorized low frequency data and/or the like) for the remaining layers of the layers 504 after introduction of such additional input portion(s).

The variant 500 produces output data 508. In some embodiments, the output data 508 includes or embodies a sequence of predictions, for example a sequence of predictions corresponding to the time steps in the input data 502. In this regard, the prediction model is configured for predicting activity for each timestamp that exists in the high-frequency data. The system, for example embodied by the apparatus 200, or an end user, may utilize all of the sequence of predictions or a particular portion thereof. For example, the system or an end user may impute missing data values from the sequence of predictions.

In some embodiments, the output data 508 may be utilized to determine a particular data value, data-driven determination, and/or the like generated based on the processed input data. In some embodiments, the output data 508 includes or embodies a prediction based on the processed input data. For example, in some embodiments, the output data 508 includes or embodies a state prediction, a missing data value (e.g., a historical missing value or a predicted next value) for one or more particular data parameter(s), and/or the like. In one example context, the output data 508 includes a state prediction indicating a prediction of whether an entity was walking, sleeping, and/or performing another activity from a set of candidate activities. Additionally or alternatively, in some embodiments, the output data 508 includes a predicted heart rate for an entity at a particular timestamp. It should be appreciated that the output data 508 may be designed to embody a result for any desired machine learning task, for example.

It should further be appreciated that each variant may be configured to learn based on introduction of the additional input data portion(s) at the different points (e.g., different layers) of the model. In this regard, each variant may perform differently from one another based on the learning differences of such variants from introduction of the additional input data portions at the different points in the training process. Each variant may then be tested, for example by a test set, to determine how well the output data 508 produced by the variant matches output truth source data, for example that represents a supervised or otherwise expected value for the output data 508. Performance data for the variant may then be determined based on whether one or more portion(s) of output data match corresponding output truth source data, In this regard, the variants may then be compared to determine which variant performs optimally for a particular machine learning task, input data types, model implementation and/or architecture, and/or the like. It should be appreciated that while the variant 500 may be an optimal variant for a particular first machine learning task and/or particular input data types, another variant may perform optimally for another machine learning task and/or other particular input data types. In this regard, training and comparison of multiple variants may be performed for each machine learning tsk, input data type(s), and/or the like, to identify and select a particular optimal variant for subsequent use in such instances.

FIG. 6 illustrates an example encoding model with attention in accordance with at least one example embodiment of the present disclosure. Specifically, FIG. 6 illustrates an example encoding model 600 that performs attention-based encoding of data for introducing a particular portion of data, for example low-frequency data, to a particular model. In some embodiments, the apparatus 400 maintains at least one computing environment including or otherwise for operating the encoding model 600.

As illustrated, the encoding model 600 includes code data vectors and time blocks 602. In some embodiments, the apparatus 400 generates the code data vectors of the code data vectors and time blocks 602 utilizing at least one low-frequency encoding model. For example, in some embodiments the apparatus 400 processes low-frequency data utilizing a low-frequency encoding model that converts codes and/or associated data for such codes to a particular data vector. In some embodiments, the apparatus 400 generates a code data vector for each unique code identified in the low-frequency data. Additionally or alternatively, in some embodiments, the time blocks include timestamp data and/or associated timing information associated with particular portions of low-frequency data. For example, in some embodiments, a time block corresponding to a particular portion of low-frequency data includes recordation timestamp embodying a date or datetime at which a portion of low-frequency data was entered into a particular record (e.g., a patient's electronic medical record). based on the recordation timestamp, for example, the time block may indicate how recently a particular claim (or set of codes for example in the low-frequency data) has occurred. Such data may be vectorized by a particular low-frequency encoding model, for example ICD2VEC or the like. In some embodiments, the code data vectors and time blocks 602 includes or embodies a set of time-by-code vectors, for example generated for each instance of a unique code in low-frequency data as depicted and described herein.

Additionally, in some embodiments, the encoding model 600 receives code-based query 604. In some embodiments, the code-based query 604 includes a projection vector for use in driving attention of the decoder in a particular model, for example the prediction model to be trained. In some embodiments, the code-based query 604 includes a constant vector, which may be shared across all patients, entities, and/or the like for a given task, for example. Additionally or alternatively, in some embodiments, the code-based query 604 includes an entity-specific vector, for example a patient-specific query vector corresponding to a particular patient.

The code data vectors and time blocks 602 and code-based query 604 are inputted to multi-head attention layer 606. In some embodiments, the multi-head attention layer 606 derives attention to particular portions of the various input data, such as code data vectors and time blocks 602 and code-based query 604. In this regard, the multi-head attention layer 606 may represent multiple parallel attention mechanisms that drives overall attention of the input data. In some embodiments, the multi-head attention layer 606 generates and/or outputs a combined vector 610 representing an attention-driven vector of the multiple inputs. Specifically, in some embodiments, the multi-head attention layer 606 learns how to weight each combination of code data vectors and time blocks 602, for example based on the code-based query 604, and combines the weights accordingly.

In this regard, the attention layer learns which data portions are particularly important for a particular prediction task. This importance is derived not only on the value of the data portions alone, but also the timestamp data corresponding to the particular data value. As such, the attention layer determines which time periods and/or time interval since a particular data value was captured. For example, a data value (e.g., a code) indicative of a heart disease diagnosis associated with a particular timestamp may be determined more important as the time interval since the particular timestamp increases, as the heart disease may get progressively worse as reflected in corresponding training data values. For other data values associated with a particular timestamp, for example a code indicative of a broken bone, the importance of the data value may decrease as the time interval since the particular timestamp increases, for example due to expected healing of the condition reflected in the corresponding training data values. Similarly, in some contexts, a code indicative a pre-existing condition may increase the importance of a particular data value or data value(s) associated with any number of codes, such as ICD codes. In this regard, in some embodiments the multi-head attention layer is trained to learn a relevance of the unique code to a state prediction, and an importance of the time differential corresponding to the unique code.

The encoding model 600 further processes the combined vector 610 together with the model representation 608. In some embodiments, the model representation 608 embodies or includes an internal representation or output of at least one of the layer(s) of the prediction model prior to introduction of the low-frequency input data. In some embodiments, the encoding model 600 inputs at least the combined vector 610 and model representation 608 to a concatenation layer 614. The concatenation layer 614 in some embodiments concatenates the output of the multi-head attention layer 606 with the internal representation embodied by the model representation 608. Additionally or alternatively, in some embodiments, the encoding model 600 concatenates the model representation 608 and combined vector 610 with one or more other data input(s), for example static data/user data 612. In some embodiments, the static data/user data 612 includes static data or other immutable or otherwise rarely changed data values associated with a particular entity (e.g., biographical data, demographic data, and/or the like corresponding to a patient). In some embodiments, the static data/user data 612 includes a vector corresponding to the particular entity for which data is being processed. For example, the static data/user data 612 in some embodiments includes a user-specific vector of data for a particular patient, which may be retrieved from a database, received from an external device, inputted by a user, and/or the like. In some embodiments, the encoding model 600 need not include the static data/user data 612.

In some embodiments, the output of the concatenation layer 614 is provided to the 1×1 convolution+ReLU layer 616, In some embodiments, the 1×1 convolution+ReLU layer 616 performs a convolution of the various types of data to combine the various input types. The resulting output of the 1×1 convolution+ReLU layer 616 may be returned to the prediction model for further processing. For example, in an example context where the prediction model embodies a U-net architecture model, the output vector of the 1×1 convolution+ReLU layer 616 may be returned to the U-net architecture model for processing as part of subsequent layers of the model. For example, the encoding model 600 may be utilized to introduce the low-frequency data 506 at a particular layer in each variant, as depicted and described with respect to FIG. 3. In this regard, the encoding model 600 generates a resulting vector that introduces particular data into the model for subsequent processing, for example introducing low-frequency data, at a particular point in the implementation of a variant of a particular model.

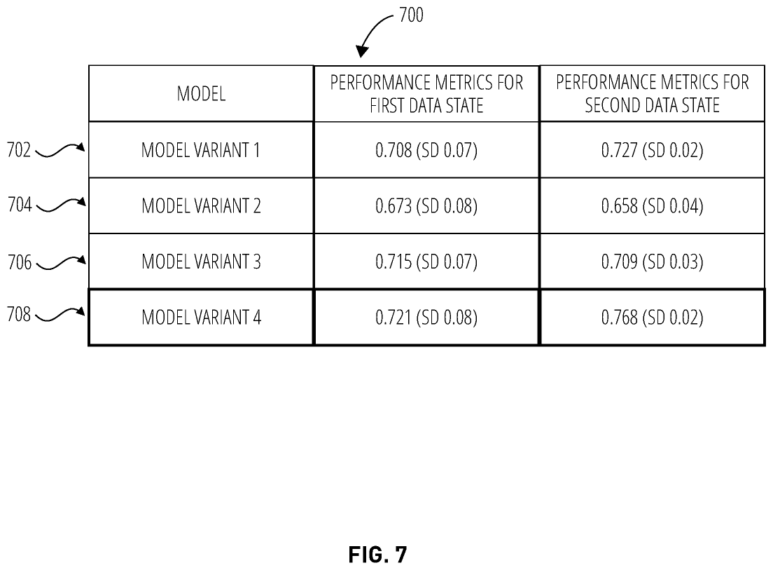

FIG. 7 illustrates an example representation of a performance data set for a plurality of variants in accordance with at least one example embodiment of the present disclosure. Specifically, FIG. 7 illustrates an example performance data set 700 depicting various performance data corresponding to various variants of a particular model. The performance data set 700 includes a first data record 702 including performance data corresponding to a first variant of a particular model (e.g., a prediction model), a second data record 704 including performance data corresponding to a second variant of a particular model, a third data record 706 including performance data corresponding to a third variant of a model, and a data record 708 including performance data corresponding to a fourth variant of a particular model. In some embodiments, the apparatus 400 generates and/or otherwise determines the performance data corresponding to each variant upon completing training of each variant as described herein, for example with respect to FIG. 5, where each variant introduces particular input data (e.g., vectorized low frequency data) at a different point in operation of the model. For example, performance data for each variant of a particular model that is trained may be determined based on comparing output of a trained variant with output truth source data corresponding to particular inputs. It will be appreciated that the apparatus 400 may generate any number of trained variants, and in this regard the performance data set 700 may include more or less data records in other embodiments where more or less variants are trained. As illustrated for example, in some embodiments the first variant represents high-frequency data processing only (e.g., no introduction of low-frequency data), the second variant represents introduction of low-frequency data at an input layer of the model, the second variant represents introduction of the low-frequency data in a separate model that modifies the output of the prediction model (e.g., after the final layer of the prediction model completes), and the fourth variant represents introduction of the low-frequency data at a second-to-last layer of the prediction model.

Additionally, as illustrated, each data record includes two portions of performance data. Specifically, each data record includes a first portion of performance data for predicting a first data state (e.g., representing accuracy of the variant with respect to a particular first state prediction by a trained variant) and a second portion of performance data for predicting a second data state (e.g., representing accuracy of the variant with respect to a particular second state prediction by a trained variant). In one example context, the first data portion of the performance data represents AUC of the ROC curve for elevated heart rate, and the second portion of the performance data represents AUC of the ROC curve for high heart rate. It will be appreciated that performance data may be collected for any number of desired states.

It will be appreciated that one or more portion(s) of the performance data from the performance data set 700 may be identified and compared. In this regard, for example, the apparatus 400 may identify such performance data with respect to a first state prediction and determines that the variant associated with optimal performance data is the fourth variant based on comparison of the values of the performance data corresponding to each variant in the data records 702-708. Similarly, the apparatus 400 may identify such performance data with respect to the second state prediction and determines that the variant associated with optimal performance data is again the fourth variant based on a subsequent comparison. In this regard, the apparatus 400 may select the fourth variant as an optimal variant for subsequent use. It will be appreciated that as illustrated, the higher value performance data indicates better performance, but in other embodiments lower data values for a particular portion of performance data may indicate better performance (e.g., where the performance data indicates an error rate of the variant).

### Example Processes of the Disclosure

Having described example systems and apparatuses, related data flows, and data architectures, in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

Although the example processes depict a particular sequence of operations, the sequence may be altered without departing from the scope of the present disclosure. For example, some of the operations depicted may be performed in parallel or in a different sequence that does not materially affect the function of the processes.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

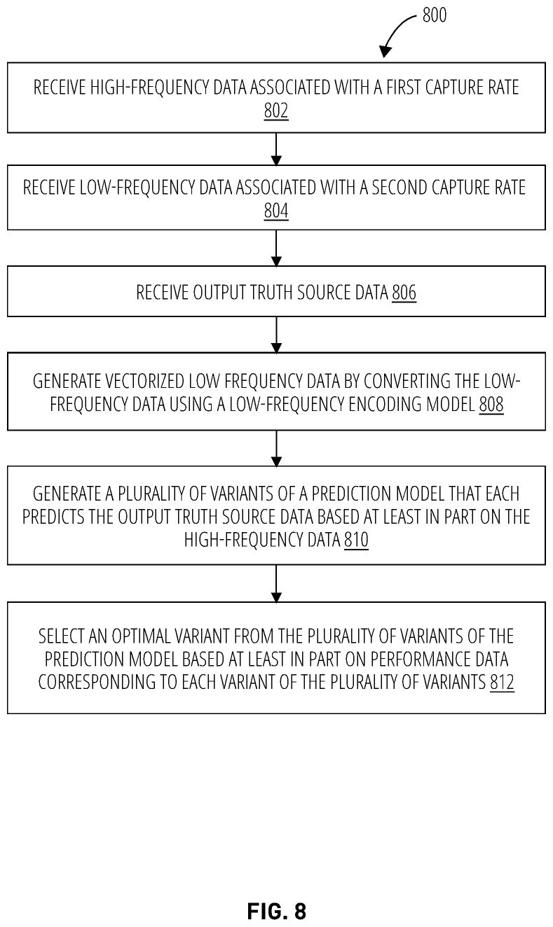

FIG. 8 illustrates a process 800 for processing different timescale data in accordance with at least one embodiment of the present disclosure. The process 800 embodies an example computer-implemented method. In some embodiments, the process 800 is embodied by computer program code stored on a non-transitory computer-readable storage medium of a computer program product configured for execution to perform the process as depicted and described. Alternatively or additionally, in some embodiments, the process 800 is performed by one or more specially configured computing devices, such as the apparatus 400 alone or in communication with one or more other component(s), device(s), system(s), and/or the like. In this regard, in some such embodiments, the apparatus 400 is specially configured by computer-coded instructions (e.g., computer program instructions) stored thereon, for example in the memory 404 and/or another component depicted and/or described herein and/or otherwise accessible to the apparatus 400, for performing the operations as depicted and described. In some embodiments, the apparatus 400 is in communication with one or more external apparatus(es), system(s), device(s), and/or the like, to perform one or more of the operations as depicted and described. For example, the apparatus 400 in some embodiments is in communication with separate component(s) of a network, external network(s), and/or the like, to perform one or more of the operation(s) as depicted and described. For purposes of simplifying the description, the process 800 is described as performed by and from the perspective of the apparatus 400.

According to some embodiments, the method includes receiving high-frequency data associated with a first capture rate at operation 802. In some embodiments, the high-frequency data represents data captured by one or more sensor(s) associated with an entity being monitored, for example an entity for which a particular prediction model is to be trained as described herein. In some embodiments, the high-frequency data is captured by a continuous glucose monitoring system, a wearable, a peripheral attached to the entity, and/or the like. The apparatus 400 in some embodiments receives the high-frequency data from the sensor itself, which may occur in real-time and/or at a previous timestamp where the apparatus 400 stores such data. Additionally or alternatively, in some embodiments, the apparatus 400 receives the high-frequency data from a data repository that stores collected high-frequency data over time. In some embodiments, the high-frequency data may include one or more data portion(s) indicating data value(s) for particular data parameter(s) and a sensed timestamp corresponding to such data values (e.g., representing the time at which such data values were captured by a sensor). In some embodiments, high-frequency data is inputted by a user in real-time or near-real-time based on output of a monitoring system. The first capture rate may define the rate at which one or more sensor(s) collect a sample that represents or is processed to determine a data value of high-frequency data. In some embodiments, high-frequency data includes data portions associated with minute intervals or aggregated over a relatively short time span (milliseconds, seconds, minutes, and/or the like) compared to a second capture rate of low-frequency data.

According to some embodiments, the method includes receiving low-frequency data associated with a second capture rate at operation 804. In some embodiments, the low-frequency data represents data inputted, captured, or otherwise received where the second capture rate is lower and/or more sporadic than the first capture rate. For example, in some embodiments, the low-frequency data is received at irregular and/or random intervals. Alternatively or additionally, in some embodiments, the low-frequency data is received at a lower regular interval than the first capture rate (e.g., weekly in a circumstance where high-frequency data is received on a minute-basis). In some embodiments, the apparatus 400 receives one or more portion(s) of low-frequency data in response to user input. Additionally or alternatively, in some embodiments, the apparatus 400 receives one or more portion(s) of low-frequency data by retrieving or otherwise receiving such portion(s) from one or more data repositories communicable with the apparatus 400.

According to some embodiments, the method includes receiving output truth source data at operation 806. In some embodiments, the output truth source data includes trusted data value(s) for output data that a prediction model should generate when fed particular corresponding input data. In some embodiments, the output truth source data is generated and/or stored by a subject matter expert. Additionally or alternatively, in some embodiments, the output truth source data is received in response to user input by the entity being monitored, or an associated technician. For example, in some embodiments, the output truth source data represents a user-maintained repository of data values maintained over a particular length of time, for example a user-maintained journal of states and corresponding timestamps for such states. Additionally or alternatively, in some embodiments, the output truth source data is received in response to the apparatus 400 generating the output truth source data based on one or more historical data values. In some embodiments, the output truth source data includes a state prediction and/or a missing data value corresponding to a particular timestamp.

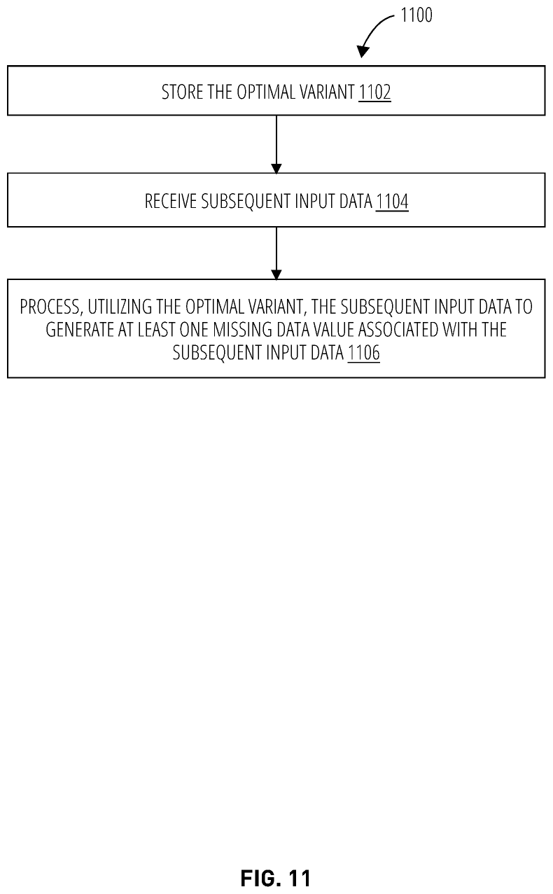

According to some embodiments, the method includes generating vectorized low frequency data by converting the low-frequency data using a low-frequency encoding model at operation 808. In some embodiments, the low-frequency encoding model embodies or includes a trained language model that extracts particular data values from one or more portion(s) of low-frequency data that correspond to particular features. For example, in some embodiments, the low-frequency encoding model identifies unique code(s) in the low-frequency data, and/or determines data values for features utilized to generate code data vectors for one or more unique codes identified in the low-frequency data. Additionally or alternatively, in some embodiments, the vectorized low frequency data is generated based on an attention model. Non-limiting examples of generating vectorized low frequency data are further described herein with respect to FIGS. 11-13.

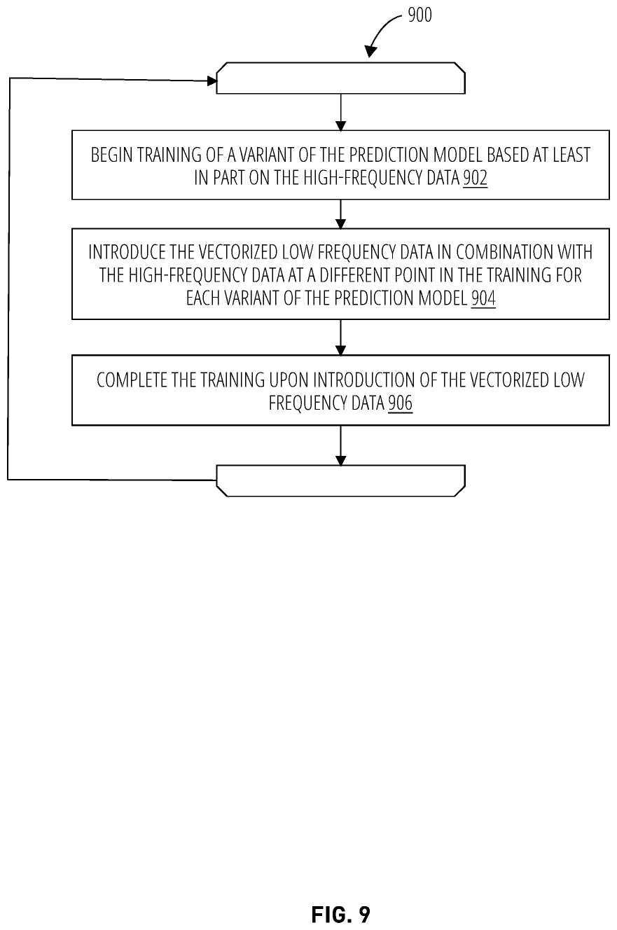

According to some embodiments, the method includes generating a plurality of variants of a prediction model that each predicts the output truth source data based on the high-frequency data at operation 810. Each variant may introduce additional input data, for example a representation of the low-frequency data and/or static data, at different points during such training of each variant. In this regard, each variant of the prediction model may perform differently for a given machine learning task. In some embodiments, the apparatus 400 begins training each of the plurality of variants of the prediction model based on the high-frequency data, and integrates the low frequency data (or a vectorized data derived therefrom as described herein) at such different stages in the training of each variant. In some embodiments, the apparatus 400 generates a variant for each possible permutation of introducing one or more additional portion(s) of input data, for example low-frequency data. For example, in some such embodiments, the apparatus 400 generates a different variant that introduces additional input data at each layer of the prediction model. Additionally or alternatively, in some embodiments, the apparatus 400 generates variants for particular determined or predetermined points of introducing the additional input data. For example, in some such embodiments, the apparatus 400 generates a different variant for each of not introducing the additional input data, introducing the additional input data at a first layer, introducing the additional input data at a second layer, introducing the additional input data at a middle layer, introducing the additional input data at a second-to-last layer, introducing the additional input data at a last layer of the prediction model, and introducing the additional input data utilizing a second model after the last layer of the prediction model, or any combination thereof. Additionally or alternatively, in some embodiments, the apparatus 400 generates a variant based on user input, for example where the user input defines what variants should be generated and trained. Non-limiting examples of generating a plurality of variants of the prediction model are further depicted and described herein with respect to FIG. 9.

According to some embodiments, the method includes selecting an optimal variant from the plurality of variants of the prediction model at operation 812. In some embodiments, the apparatus 400 selects the optimal variant based on performance data corresponding to each variant of the plurality of variants. For example, in some embodiments, the apparatus 400 generates and/or receives performance data for each variant after completion of the training of each variant. In some embodiments, the apparatus 400 generates the performance data for a particular variant by processing a test data set utilizing the variant and determining an accuracy of the variant of the prediction model based on the test set. In some embodiments, the test data set embodies a second set of output truth source data, including known data values to be outputted by the variant of the prediction model, and corresponding portion(s) of input data, for example high-frequency data, low-frequency data, and/or static data. The apparatus 400 in some such embodiments selects the optimal variant that includes the most optimal or best performance data. For example, the optimal performance data may include the highest data value of the performance data in some contexts (e.g., most accurate), or the lowest data value of the performance data in other contexts (e.g., lowest error rate). In some embodiments, the apparatus 400 utilizes a mathematical formula or other selection algorithm to determine the optimal variant, for example where multiple portions of performance data are weighted and/or combined for different use cases and/or processed test sets of output truth source data.

FIG. 9 illustrates a sub-process of processing different timescale data, in accordance with at least one example embodiment of the present disclosure. Specifically, FIG. 9 illustrates a process 900 for generating a plurality of variants of a prediction model. The process 900 embodies an example computer-implemented method. In some embodiments, the process 900 is embodied by computer program code stored on a non-transitory computer-readable storage medium of a computer program product configured for execution to perform the process as depicted and described. Alternatively or additionally, in some embodiments, the process 900 is performed by one or more specially configured computing devices, such as the apparatus 400 alone or in communication with one or more other component(s), device(s), system(s), and/or the like. In this regard, in some such embodiments, the apparatus 400 is specially configured by computer-coded instructions (e.g., computer program instructions) stored thereon, for example in the memory 404 and/or another component depicted and/or described herein and/or otherwise accessible to the apparatus 400, for performing the operations as depicted and described. In some embodiments, the apparatus 400 is in communication with one or more external apparatus(es), system(s), device(s), and/or the like, to perform one or more of the operations as depicted and described. For example, the apparatus 400 in some embodiments is in communication with a separate primary system, client system, and/or the like. For purposes of simplifying the description, the process 900 is described as performed by and from the perspective of the apparatus 400.

In some embodiments, the process 900 begins at operation 902. In some embodiments, the process 900 begins after one or more operational blocks depicted and/or described with respect to any one of the other processes described herein. In this regard, some or all of the process 900 may replace or supplement one or more operations depicted and/or described with respect to any of the processes described herein. For example, in some embodiments, the process 900 begins after operation 808, and may replace, supplant, and/or otherwise supplement one or more operations of the process 800. Upon completion of the process 900, the flow of operations may terminate. Additionally or alternatively, as depicted, upon completion of the process 900 in some embodiments, flow may return to one or more operation(s) of another process, such as the operation 812. It will be appreciated that, in some embodiments, the process 900 embodies a sub-process of one or more other process(es) depicted and/or described herein, for example the process 800.

In some embodiments, the process 900 is repeated any number of times. For example, in some embodiments, the apparatus 400 repeats the process 900 for each variant of a prediction model to be generated. In this regard, the process 900 may be repeated until a maximum number of variants is reached, until a variant corresponding to each layer of a prediction model is generated, and/or until another data-driven determination is satisfied. In some embodiments, the apparatus 400 repeats for each variant determined to be generated at operation 810.

According to some embodiments, the method includes beginning training of a variant of the prediction model based on the high-frequency data at operation 902. In some embodiments, the apparatus 400 begins training of a variant by introducing high-frequency data (and/or data derived therefrom) to an input layer of an instance of the prediction model, where the instance of the prediction model embodies the variant. In this regard, the variant of the prediction model may process the high-frequency data, and/or associated output truth source data for example, at one or more layer(s) to train internal weights associated with one or more layer(s) of the particular variant of the prediction model. The apparatus 400 may maintain separate data objects representing each variant of the prediction model during training.

According to some embodiments, the method includes introducing the vectorized low frequency data in combination with the high-frequency data at a different point in the training for each variant of the prediction model at operation 904. In this regard, each variant may be assigned or otherwise associated with a different point in the training process at which the vectorized low frequency data is introduced. For example, in some embodiments, a particular variant is configured to introduce low-frequency data, and/or the vectorized low frequency data or the like, at a particular layer during training of that particular variant. In this regard, once the vectorized low frequency data is introduced at a particular layer, for example, subsequent layers may similarly process the high-frequency data concatenated or otherwise combined with the additionally added input data embodying the vectorized low frequency data. In some embodiments, one or more other additional input data portions is/are similarly introduced with the vectorized low frequency data at a different point, for example static data, user-specific vector, and/or the like. Such other additional input data potions may be introduced at the same point as the vectorized low frequency data, and/or in some embodiments the apparatus 400 introduces the other additional input data portions at different points than the high-frequency data and/or the vectorized low frequency data.

According to some embodiments, the method includes completing the training upon introduction of the vectorized low frequency data at operation 906. In some embodiments, the apparatus 400 completes the training of the particular variant by continuing to process the input data including the high-frequency data and vectorized low frequency data (and/or other additional data input(s)) at each subsequent layer of the processing model. In this regard, subsequent to introduction of the vectorized low frequency data, and/or any other additional input data, the training of the variant may learn from data relationships, trends, and/or the like derived from the combined input data. In this regard, it will be appreciated that even when variants are trained on the same training data (e.g., high-frequency data, low-frequency data, and output truth source data, for example), the different variants may generate different weights based on the individual learnings of each variant after introduction of the additional input data (e.g., vectorized low frequency data and user-specific vector(s) or other data) at different points in the training for each variant.

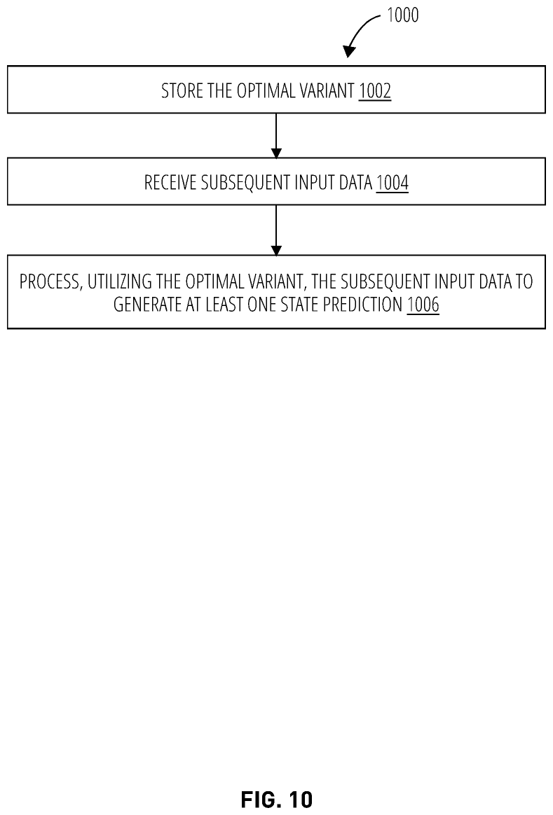

FIG. 10 illustrates a sub-process of processing different timescale data, in accordance with at least one example embodiment of the present disclosure. Specifically, FIG. 10 illustrates a process 1000 for utilizing an optimal variant to generate at least one state prediction. The process 1000 embodies an example computer-implemented method. In some embodiments, the process 1000 is embodied by computer program code stored on a non-transitory computer-readable storage medium of a computer program product configured for execution to perform the process as depicted and described. Alternatively or additionally, in some embodiments, the process 1000 is performed by one or more specially configured computing devices, such as the apparatus 400 alone or in communication with one or more other component(s), device(s), system(s), and/or the like. In this regard, in some such embodiments, the apparatus 400 is specially configured by computer-coded instructions (e.g., computer program instructions) stored thereon, for example in the memory 404 and/or another component depicted and/or described herein and/or otherwise accessible to the apparatus 400, for performing the operations as depicted and described. In some embodiments, the apparatus 400 is in communication with one or more external apparatus(es), system(s), device(s), and/or the like, to perform one or more of the operations as depicted and described. For example, the apparatus 400 in some embodiments is in communication with a separate primary system, client system, and/or the like. For purposes of simplifying the description, the process 1000 is described as performed by and from the perspective of the apparatus 400.

In some embodiments, the process 1000 begins at operation 1002. In some embodiments, the process 1000 begins after one or more operational blocks depicted and/or described with respect to any one of the other processes described herein. In this regard, some or all of the process 1000 may replace or supplement one or more operations depicted and/or described with respect to any of the processes described herein. For example, in some embodiments, the process 1000 begins after operation 812, and may replace, supplant, and/or otherwise supplement one or more operations of the process 800. Upon completion of the process 1000, the flow of operations may terminate. Additionally or alternatively, as depicted, upon completion of the process 1000 in some embodiments, flow may return to one or more operation(s) of another process. It will be appreciated that, in some embodiments, the process 1000 embodies a sub-process of one or more other process(es) depicted and/or described herein, for example the process 800.

According to some embodiments, the method includes storing the optimal variant at operation 1002. In some embodiments, the apparatus 400 stores the optimal variant to a memory of the apparatus 400. In this regard, the apparatus 400 may retrieve the optimal variant from the memory for subsequent use. In some embodiments, the apparatus 400 stores the optimal variant to another device and/or system that utilizes the optimal variant of the prediction model to generate an output. For example, in some embodiments, the apparatus 400 transmits the optimal variant to an external system for storage.

According to some embodiments, the method includes receiving subsequent input data at operation 1004. In some embodiments, the subsequent input data includes subsequent high-frequency data. The subsequent high-frequency data may be received from a sensor, or retrieved from one or more data repository, for processing to generate new output data based on the subsequent high-frequency data. Additionally or alternatively, in some embodiments, the subsequent input data includes subsequent low-frequency data. In some embodiments, the subsequent low-frequency data includes an updated data record including one or more portions of low-frequency data, for example where the subsequent low-frequency data includes one or more new portion(s) not utilized to train the optimal variant. Additionally or alternatively, in some embodiments, no subsequent low-frequency data may be received, for example where the low-frequency data corresponding to a particular entity remains unchanged. In some embodiments, for example where the low-frequency data embodies an electronical medical record for a particular patient, the apparatus 400 may receive subsequent low-frequency data in circumstances where the patient has undergone a new medical event.

According to some embodiments, the method includes processing, utilizing the optimal variant, the subsequent input data to generate at least one state prediction at operation 1006. In some embodiments, the apparatus 400 inputs subsequent high-frequency data of the subsequent input to the optimal variant for processing. The optimal variant additionally or alternatively may introduce a second portion of the subsequent input data, for example low-frequency data that remains unchanged or subsequent low-frequency data, at a particular point based on the configuration of the optimal variant. The optimal variant may continue to process such data to produce output data representing the state prediction.

FIG. 11 illustrates a sub-process of processing different timescale data, in accordance with at least one example embodiment of the present disclosure. Specifically, FIG. 11 illustrates a process 1100 for utilizing an optimal variant to generate at least one missing data value. The process 1100 embodies an example computer-implemented method. In some embodiments, the process 1100 is embodied by computer program code stored on a non-transitory computer-readable storage medium of a computer program product configured for execution to perform the process as depicted and described. Alternatively or additionally, in some embodiments, the process 1100 is performed by one or more specially configured computing devices, such as the apparatus 400 alone or in communication with one or more other component(s), device(s), system(s), and/or the like. In this regard, in some such embodiments, the apparatus 400 is specially configured by computer-coded instructions (e.g., computer program instructions) stored thereon, for example in the memory 404 and/or another component depicted and/or described herein and/or otherwise accessible to the apparatus 400, for performing the operations as depicted and described. In some embodiments, the apparatus 400 is in communication with one or more external apparatus(es), system(s), device(s), and/or the like, to perform one or more of the operations as depicted and described. For example, the apparatus 400 in some embodiments is in communication with a separate primary system, client system, and/or the like. For purposes of simplifying the description, the process 1100 is described as performed by and from the perspective of the apparatus 400.

In some embodiments, the process 1100 begins at operation 1102. In some embodiments, the process 1100 begins after one or more operational blocks depicted and/or described with respect to any one of the other processes described herein. In this regard, some or all of the process 1100 may replace or supplement one or more operations depicted and/or described with respect to any of the processes described herein. For example, in some embodiments, the process 1100 begins after operation 812, and may replace, supplant, and/or otherwise supplement one or more operations of the process 800. Upon completion of the process 1100, the flow of operations may terminate. Additionally or alternatively, as depicted, upon completion of the process 1100 in some embodiments, flow may return to one or more operation(s) of another process. It will be appreciated that, in some embodiments, the process 1100 embodies a sub-process of one or more other process(es) depicted and/or described herein, for example the process 800.

According to some embodiments, the method includes storing the optimal variant at operation 1102. In some embodiments, the apparatus 400 stores the optimal variant to a memory of the apparatus 400. In this regard, the apparatus 400 may retrieve the optimal variant from the memory for subsequent use. In some embodiments, the apparatus 400 stores the optimal variant to another device and/or system that utilizes the optimal variant of the prediction model to generate an output. For example, in some embodiments, the apparatus 400 transmits the optimal variant to an external system for storage.

According to some embodiments, the method includes receiving subsequent input data at operation 1104. In some embodiments, the subsequent input data includes subsequent high-frequency data. The subsequent high-frequency data may be received from a sensor, or retrieved from one or more data repository, for processing to generate new output data based on the subsequent high-frequency data. Additionally or alternatively, in some embodiments, the subsequent input data includes subsequent low-frequency data. In some embodiments, the subsequent low-frequency data includes an updated data record including one or more portions of low-frequency data, for example where the subsequent low-frequency data includes one or more new portion(s) not utilized to train the optimal variant. Additionally or alternatively, in some embodiments, no subsequent low-frequency data may be received, for example where the low-frequency data corresponding to a particular entity remains unchanged. In some embodiments, for example where the low-frequency data embodies an electronical medical record for a particular patient, the apparatus 400 may receive subsequent low-frequency data in circumstances where the patient has undergone a new medical event.

According to some embodiments, the method includes processing, utilizing the optimal variant, the subsequent input data to generate at least one missing data value associated with the subsequent input data at operation 1106. In some embodiments, the apparatus 400 inputs subsequent high-frequency data of the subsequent input data to the optimal variant for processing. The optimal variant additionally or alternatively may introduce a second portion of the subsequent input data, for example low-frequency data that remains unchanged or subsequent low-frequency data, at a particular point based on the configuration of the optimal variant. The optimal variant may continue to process such input data to produce output data representing the missing data value. In some embodiments, the missing data value includes a predicted data value for a historical timestamp not captured or included in the input data. Additionally or alternatively, in some embodiments, the missing data value includes a predicted data value for a subsequent or future timestamp, for example the next data value predicted in a time series.

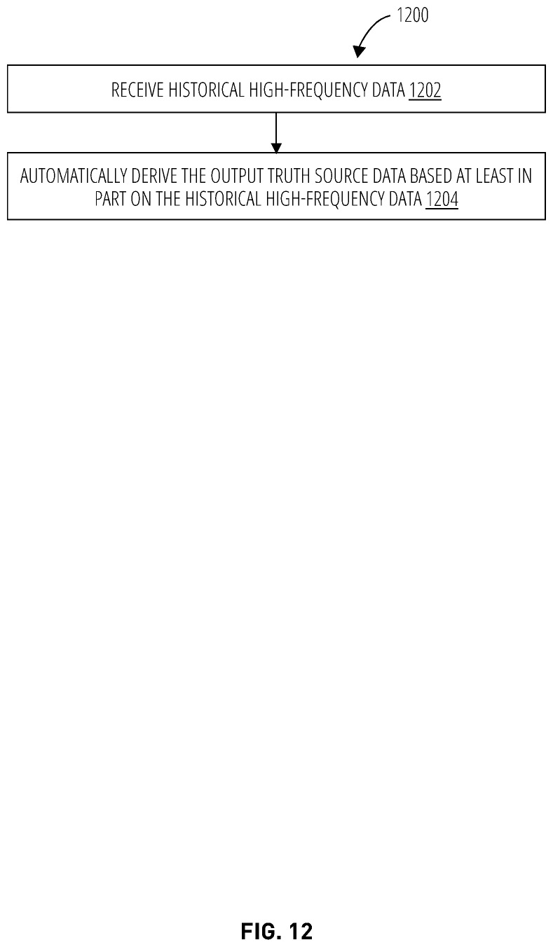

FIG. 12 illustrates a sub-process of processing different timescale data, in accordance with at least one example embodiment of the present disclosure. Specifically, FIG. 12 illustrates a process 1200 for receiving output truth source data. The process 1200 embodies an example computer-implemented method. In some embodiments, the process 1200 is embodied by computer program code stored on a non-transitory computer-readable storage medium of a computer program product configured for execution to perform the process as depicted and described. Alternatively or additionally, in some embodiments, the process 1200 is performed by one or more specially configured computing devices, such as the apparatus 400 alone or in communication with one or more other component(s), device(s), system(s), and/or the like. In this regard, in some such embodiments, the apparatus 400 is specially configured by computer-coded instructions (e.g., computer program instructions) stored thereon, for example in the memory 404 and/or another component depicted and/or described herein and/or otherwise accessible to the apparatus 400, for performing the operations as depicted and described. In some embodiments, the apparatus 400 is in communication with one or more external apparatus(es), system(s), device(s), and/or the like, to perform one or more of the operations as depicted and described. For example, the apparatus 400 in some embodiments is in communication with a separate primary system, client system, and/or the like. For purposes of simplifying the description, the process 1200 is described as performed by and from the perspective of the apparatus 400.

In some embodiments, the process 1200 begins at operation 1202. In some embodiments, the process 1200 begins after one or more operational blocks depicted and/or described with respect to any one of the other processes described herein. In this regard, some or all of the process 1200 may replace or supplement one or more operations depicted and/or described with respect to any of the processes described herein. For example, in some embodiments, the process 1200 begins after operation 804, and may replace, supplant, and/or otherwise supplement one or more operations of the process 800. Upon completion of the process 1200, the flow of operations may terminate. Additionally or alternatively, as depicted, upon completion of the process 1200 in some embodiments, flow may return to one or more operation(s) of another process, such as the operation 808. It will be appreciated that, in some embodiments, the process 1200 embodies a sub-process of one or more other process(es) depicted and/or described herein, for example the process 800.

According to some embodiments, the method includes receiving historical high-frequency data at operation 1202. In some embodiments, the apparatus 400 captures and/or otherwise receives portion(s) of the historical high-frequency data over time. For example, in some embodiments, as new portions of high-frequency data are captured, such data portions may be received and/or stored by the apparatus 400. Additionally or alternatively, in some embodiments, the apparatus 400 receives the historical high-frequency data in one or more data record(s), for example from a data repository embodying a centralized storage of high-frequency data over time.

According to some embodiments, the method includes deriving the output truth source data based on the historical high-frequency data at operation 1204. For example, in some embodiments, the apparatus 400 processes the historical high-frequency data utilizing a rules engine. The rules engine may process the historical high-frequency data to generate corresponding portion(s) of output truth source data based on the historical high-frequency data.

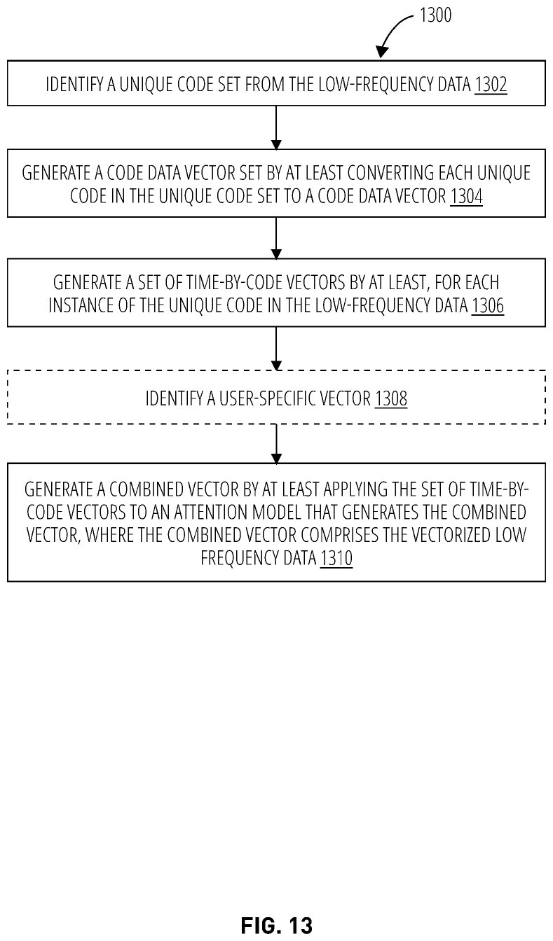

FIG. 13 illustrates a sub-process of processing different timescale data, in accordance with at least one example embodiment of the present disclosure. Specifically, FIG. 13 illustrates a process 1300 for generating vectorized low frequency data. The process 1300 embodies an example computer-implemented method. In some embodiments, the process 1300 is embodied by computer program code stored on a non-transitory computer-readable storage medium of a computer program product configured for execution to perform the process as depicted and described. Alternatively or additionally, in some embodiments, the process 1300 is performed by one or more specially configured computing devices, such as the apparatus 400 alone or in communication with one or more other component(s), device(s), system(s), and/or the like. In this regard, in some such embodiments, the apparatus 400 is specially configured by computer-coded instructions (e.g., computer program instructions) stored thereon, for example in the memory 404 and/or another component depicted and/or described herein and/or otherwise accessible to the apparatus 400, for performing the operations as depicted and described. In some embodiments, the apparatus 400 is in communication with one or more external apparatus(es), system(s), device(s), and/or the like, to perform one or more of the operations as depicted and described. For example, the apparatus 400 in some embodiments is in communication with a separate primary system, client system, and/or the like. For purposes of simplifying the description, the process 1300 is described as performed by and from the perspective of the apparatus 400.

In some embodiments, the process 1300 begins at operation 1302. In some embodiments, the process 1300 begins after one or more operational blocks depicted and/or described with respect to any one of the other processes described herein. In this regard, some or all of the process 1300 may replace or supplement one or more operations depicted and/or described with respect to any of the processes described herein. For example, in some embodiments, the process 1300 begins after operation 806, and may replace, supplant, and/or otherwise supplement one or more operations of the process 800. Upon completion of the process 900, the flow of operations may terminate. Additionally or alternatively, as depicted, upon completion of the process 1300 in some embodiments, flow may return to one or more operation(s) of another process, such as the operation 810. It will be appreciated that, in some embodiments, the process 1300 embodies a sub-process of one or more other process(es) depicted and/or described herein, for example the process 800.

According to some embodiments, the method includes identifying a unique code set from the low-frequency data at operation 1302. In some embodiments, the apparatus 400 processes the low-frequency data utilizing one or more trained language model and/or trained image model that identifies and/or extracts each unique code within the low-frequency data. In some embodiments, the apparatus 400 identifies each data portion representing a code and determines whether the code has been previously identified in the low-frequency data, where each unique code is identified upon first instance from within the low-frequency data.

According to some embodiments, the method includes generating a code data vector set by at least converting each unique code in the unique code set to a code data vector at operation 1304. In some embodiments, the apparatus 400 converts a particular unique code utilizing a vectorization model. For example, in some embodiments, the vectorization model includes or is embodied by an ICD2VEC model, or other model that extracts particular features corresponding to a particular unique code from the low-frequency data.

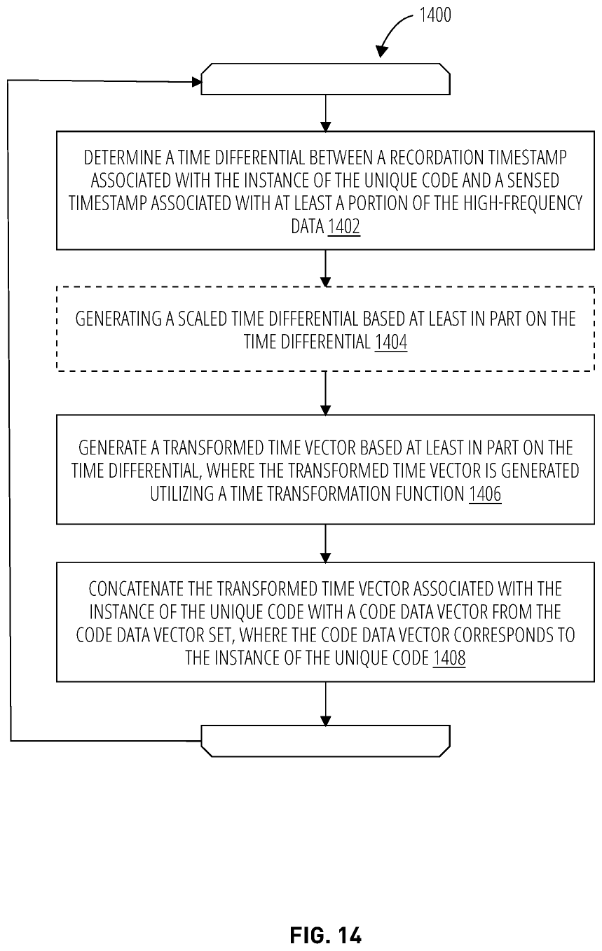

According to some embodiments, the method includes generating a set of time-by-code vectors at operation 1306. In some embodiments, the apparatus 400 generates a time-by-code vector for each instance of a unique code identified in the low-frequency data. For example, the apparatus 400 may track each unique code in the unique code set, and separately identify and/or track each instance of a particular unique code for further processing. The set of time-by-code vector includes at least one time-by-code vector, where each time-by-code vector includes a concatenation or other combination of a time vector with a corresponding code data vector. In some embodiments, the apparatus 400 processes each code data vector corresponding to each instance of a unique code in the low-frequency data and associated timestamp data. Non-limiting example processes for generating a set of time-by-code vectors is depicted and described with respect to FIG. 14.

According to some embodiments, the method optionally includes identifying a user-specific vector at optional operation 1308. In some embodiments, the apparatus 400 identifies the user-specific vector from a data repository maintained by or otherwise accessible to the apparatus 400. Additionally or alternatively, in some embodiments, the apparatus 400 identifies the user-specific vector by receiving the user-specific vector from an external system, monitor, and/or the like. Additionally or alternatively still, in some embodiments, the apparatus 400 identifies the user-specific vector in response to user input data representing the user-specific vector.

In some embodiments, the user-specific vector includes static, immutable, or rarely changed data corresponding to a particular entity for which data is being processed. For example, in some embodiments, the apparatus 400 identifies a user-specific vector that corresponds to the entity associated with the high-frequency data and/or low-frequency data being monitored (e.g., an entity wearing a continuous glucose monitor and having their electronic medical record being processed). In some embodiments, the apparatus 400 identifies a user-specific vector including patient demographic data. In other embodiments, the apparatus 400 identifies other static data that is introduced for processing.

According to some embodiments, the method includes generating a combined vector at operation 1310. In some embodiments, the apparatus 400 generates a combined vector by at least applying the set of time-by-code vectors to an attention model. The attention model may generate the combined vector by combining the time blocks of a time-by-code vector and the code data vector of the time-by-code vector in a manner that emphasizes particular elements or relationships in the data. For example, the attention model in some embodiments learns what portions of data are relevant to a particular machine learning task and/or the effects of time differentials between the recordation timestamp associated with a code and the timestamp at which processing is occurring.

FIG. 14 illustrates a sub-process of processing different timescale data, in accordance with at least one example embodiment of the present disclosure. Specifically, FIG. 14 illustrates a process 1400 for generating a set of time-by-code vectors. The process 1400 embodies an example computer-implemented method. In some embodiments, the process 1400 is embodied by computer program code stored on a non-transitory computer-readable storage medium of a computer program product configured for execution to perform the process as depicted and described. Alternatively or additionally, in some embodiments, the process 1400 is performed by one or more specially configured computing devices, such as the apparatus 400 alone or in communication with one or more other component(s), device(s), system(s), and/or the like. In this regard, in some such embodiments, the apparatus 400 is specially configured by computer-coded instructions (e.g., computer program instructions) stored thereon, for example in the memory 404 and/or another component depicted and/or described herein and/or otherwise accessible to the apparatus 400, for performing the operations as depicted and described. In some embodiments, the apparatus 400 is in communication with one or more external apparatus(es), system(s), device(s), and/or the like, to perform one or more of the operations as depicted and described. For example, the apparatus 400 in some embodiments is in communication with a separate primary system, client system, and/or the like. For purposes of simplifying the description, the process 1400 is described as performed by and from the perspective of the apparatus 400.

In some embodiments, the process 1400 begins at operation 1402. In some embodiments, the process 1400 begins after one or more operational blocks depicted and/or described with respect to any one of the other processes described herein. In this regard, some or all of the process 1400 may replace or supplement one or more operations depicted and/or described with respect to any of the processes described herein. For example, in some embodiments, the process 1400 begins after operation 1304, and may replace, supplant, and/or otherwise supplement one or more operations of the process 1300. Upon completion of the process 1400, the flow of operations may terminate. Additionally or alternatively, as depicted, upon completion of the process 1400 in some embodiments, flow may return to one or more operation(s) of another process, such as the optional operation 1308. It will be appreciated that, in some embodiments, the process 1400 embodies a sub-process of one or more other process(es) depicted and/or described herein, for example the process 1300.

In some embodiments, the process 1400 is repeated any number of times. For example, in some embodiments, the apparatus 400 repeats the process 1400 for each instance of a unique code in low-frequency data. In this regard, the process 1400 may be repeated to generate a time-by-code vector for each such instance of unique code. In some embodiments, the apparatus 400 repeats for each code data vector generated at operation 1304,

According to some embodiments, the method includes determining a time differential at operation 1402. In some embodiments, the apparatus 400 determines the time differential representing the difference between a recordation timestamp associated with an instance of the unique code and a sensed timestamp associated with at least a portion of the high-frequency data. In this regard, the time differential may be determined based on the sensed timestamp for a particular portion of high-frequency data corresponding to a captured measurement and may be processed in parallel for different portions of the high-frequency data. It will be appreciated that in some embodiments, the apparatus 400 determines the time differential based on subtracting the recordation timestamp from the sensed timestamp, or any other time difference determination algorithm.

According to some embodiments, the method includes generating a scaled time differential based on the time differential at optional operation 1404. In some embodiments, the scaled time differential is converted to a preferable time scale that enables accurate comparison of events in a particular timeline. In some embodiments the apparatus 400 generates the scaled time differential by applying the time differential to a scaling function. In some embodiments, the scaling function embodies a logarithmic transformation (e.g., such that timestamps may be compared on a logarithmic timescale). In other embodiments, the apparatus 400 is configured to utilize another scaling function. In other embodiments, the apparatus 400 does not scale the time differential for further processing.

According to some embodiments, the method includes generating a transformed time vector based on the time differential at operation 1406. In some embodiments, the transformed time vector is generated utilizing a time transformation function. For example, in some embodiments, the apparatus 400 applies the time differential to the time transformation function to generate the transformed time vector. In at least some other embodiments, the apparatus 400 applies the scaled time differential to the time transformation function. In some embodiments, the time transformation function embodies a sine transformation function. In other embodiments, the time transformation function embodies a cosine transformation function. Additionally or alternatively, in some embodiments, the time transformation function embodies a combination of sine transformation functions and cosine transformation functions, and/or a combination of any other transformation functions.

According to some embodiments, the method includes concatenating the transformed time vector associated with the instance of the unique code with a code data vector from the code data vector set at operation 1408. In some such embodiments, the code data vector corresponds to the particular instance of the unique code. In this regard, the concatenation of the transformed time vector and the corresponding code data vector may embody a particular time-by-code vector for a particular unique code. In some embodiments, the apparatus 400 stores the generated time-by-code vector to a set, for example embodying the set of time-by-code vectors. The time-by-code vector for each unique code may be further processed as described herein.

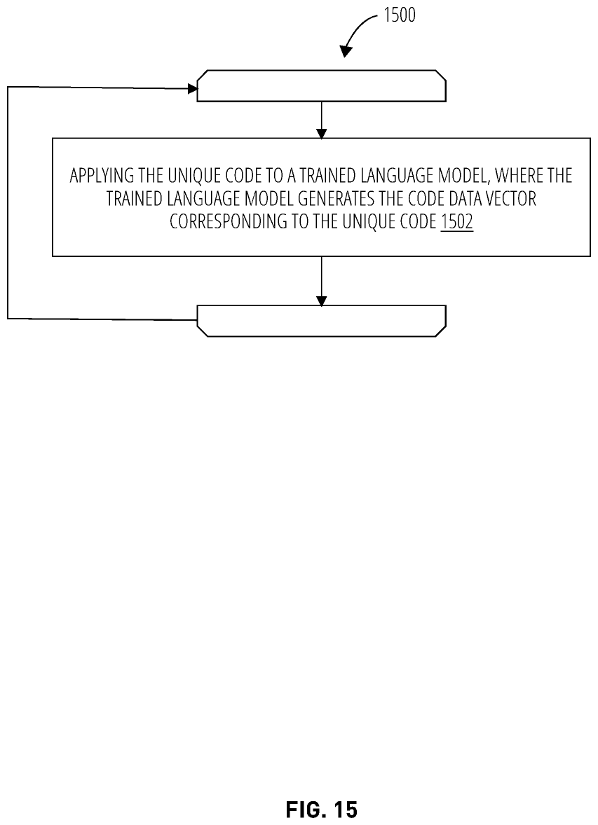

FIG. 15 illustrates a sub-process of processing different timescale data, in accordance with at least one example embodiment of the present disclosure. Specifically, FIG. 15 illustrates a process 1500 for converting at least one unique code to a code data vector. The process 1500 embodies an example computer-implemented method. In some embodiments, the process 1500 is embodied by computer program code stored on a non-transitory computer-readable storage medium of a computer program product configured for execution to perform the process as depicted and described. Alternatively or additionally, in some embodiments, the process 1500 is performed by one or more specially configured computing devices, such as the apparatus 400 alone or in communication with one or more other component(s), device(s), system(s), and/or the like. In this regard, in some such embodiments, the apparatus 400 is specially configured by computer-coded instructions (e.g., computer program instructions) stored thereon, for example in the memory 404 and/or another component depicted and/or described herein and/or otherwise accessible to the apparatus 400, for performing the operations as depicted and described. In some embodiments, the apparatus 400 is in communication with one or more external apparatus(es), system(s), device(s), and/or the like, to perform one or more of the operations as depicted and described. For example, the apparatus 400 in some embodiments is in communication with a separate primary system, client system, and/or the like. For purposes of simplifying the description, the process 1500 is described as performed by and from the perspective of the apparatus 400.

In some embodiments, the process 1500 begins at operation 1502. In some embodiments, the process 1500 begins after one or more operational blocks depicted and/or described with respect to any one of the other processes described herein. In this regard, some or all of the process 1500 may replace or supplement one or more operations depicted and/or described with respect to any of the processes described herein. For example, in some embodiments, the process 1500 begins after operation 1302, and may replace, supplant, and/or otherwise supplement one or more operations of the process 1300. Upon completion of the process 1500, the flow of operations may terminate. Additionally or alternatively, as depicted, upon completion of the process 1500 in some embodiments, flow may return to one or more operation(s) of another process, such as the operation 1306. It will be appreciated that, in some embodiments, the process 1500 embodies a sub-process of one or more other process(es) depicted and/or described herein, for example the process 1300.

In some embodiments, the process 1500 is repeated any number of times. For example, in some embodiments, the apparatus 400 repeats the process 1500 for each unique code detected or otherwise identified in low-frequency data. In some embodiments, the process 1500 repeats for each such unique code identified in the unique code set of operation 1302.

According to some embodiments, the method includes applying the unique code to a trained language model at operation 1502. In some embodiments, the trained language model generates the code data vector corresponding to the unique code. For example, in some embodiments, the trained language model includes a natural language processing model that extracts particular keyword(s), phrase(s), and/or other text determined relevant from low-frequency data. In some embodiments, the trained language model determines text representing or relevant to a code in the low-frequency data, for example including one or more feature(s) associated with a medical code represented in the low-frequency data including one or more portion(s) of a patient's electronic medical record. In this regard, the apparatus 400 may utilize the data outputted from the trained language model as features that are included in a code data vector generated for the particular unique code identified in the low-frequency data.

### CONCLUSION

Embodiments of the present disclosure can be implemented in various ways, including as computer program products that comprise articles of manufacture. Such computer program products can include one or more software components including, for example, software objects, methods, data structures, or the like. A software component can be coded in any of a variety of programming languages. An illustrative programming language can be a lower-level programming language such as an assembly language associated with a particular hardware architecture and/or operating system platform. A software component comprising assembly language instructions can require conversion into executable machine code by an assembler prior to execution by the hardware architecture and/or platform. Another example programming language can be a higher-level programming language that can be portable across multiple architectures. A software component comprising higher-level programming language instructions can require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages can be executed directly by an operating system or other software component without having to be first transformed into another form. A software component can be stored as a file or other data storage construct. Software components of a similar type or functionally related can be stored together such as, for example, in a particular directory, folder, or library. Software components can be static (e.g., pre-established, or fixed) or dynamic (e.g., created or modified at the time of execution).

A computer program product can include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium can include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium can also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium can also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium can also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium can include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media can be substituted for or used in addition to the computer-readable storage media described above.

As should be appreciated, various embodiments of the present disclosure can also be implemented as methods, apparatus, systems, computing devices, computing entities, and/or the like. As such, embodiments of the present disclosure can take the form of an apparatus, system, computing device, computing entity, and/or the like executing instructions stored on a non-transitory computer-readable storage medium to perform certain steps or operations. Thus, embodiments of the present disclosure can also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations can be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a non-transitory computer-readable storage medium for execution. For example, retrieval, loading, and execution of code can be performed sequentially such that one instruction is retrieved, loaded, and executed at a time. In some exemplary embodiments, retrieval, loading, and/or execution can be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, e.g., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, by one or more processors, high-frequency data associated with a first capture rate and low-frequency data associated with a second capture rate;
generating, by the one or more processors, vectorized low frequency data by converting the low-frequency data using a low-frequency encoding model; and
processing, by the one or more processors and utilizing a prediction model, the high-frequency data and the vectorized low-frequency data to generate output data.

2. The computer-implemented method of claim 1, further comprising:
receiving, by one or more processors, output truth source data;
generating, by the one or more processors, a plurality of variants of the prediction model, wherein each variant predicts the output truth source data based at least in part on the high-frequency data by at least:
(1) introducing the vectorized low frequency data in combination with the high-frequency data at a different point in the training for each variant of the plurality of variants of the prediction model, and
(2) completing the training upon introduction of the vectorized low frequency data; and
selecting, by the one or more processors, an optimal variant from the plurality of variants of the prediction model based at least in part on performance data corresponding to each variant of the plurality of variants,
wherein the prediction model utilized to generate the output data comprises the optimal variant.

3. The computer-implemented method of claim 1, wherein processing the high-frequency data and the vectorized low-frequency data to generate output data comprises:
processing, utilizing the prediction model processing the high-frequency data and the vectorized low-frequency data to generate at least one state prediction.

4. The computer-implemented method of claim 1, further comprising:
processing, utilizing the prediction model processing the high-frequency data and the vectorized low-frequency data to generate at least one missing data value associated with the high-frequency data.

5. The computer-implemented method of claim 1, wherein the prediction model comprises a modified U-net architecture model.

6. The computer-implemented method of claim 1, wherein receiving the high-frequency data comprises capturing the high-frequency data utilizing at least one sensor.

7. The computer-implemented method of claim 2, wherein receiving the output truth source data comprises receiving user input indicating at least one state associated with at least one portion of the low-frequency data and at least one portion of the high-frequency data.

8. The computer-implemented method of claim 2, wherein receiving the output truth source data comprises:
receiving historical high-frequency data; and
deriving the output truth source data based at least in part on the historical high-frequency data.

9. The computer-implemented method of claim 1, wherein generating the vectorized low frequency data by converting the low-frequency data using the low-frequency encoding model comprises:
identifying a unique code set from the low-frequency data;
generating a code data vector set by at least converting each unique code in the unique code set to a code data vector;
generating a set of time-by-code vectors by at least, for each instance of the unique code in the low-frequency data:
determining a time differential between a recordation timestamp associated with the instance of the unique code and a sensed timestamp associated with at least a portion of the high-frequency data;
generating a transformed time vector based at least in part on the time differential, wherein the transformed time vector is generated utilizing a time transformation function;
concatenate the transformed time vector associated with the instance of the unique code with a code data vector from the code data vector set, wherein the code data vector corresponds to the instance of the unique code; and
generating a combined vector by at least applying the set of time-by-code vectors to an attention model that generates the combined vector,
wherein the combined vector comprises the vectorized low frequency data.

10. The computer-implemented method of claim 9, wherein the combined vector comprises a weighted average of each time-by-code vector in the set of time-by-code vectors, wherein the weighted average is determined based at least in part on a set of weights generated utilizing the attention model comprising a multi-head attention layer.

11. The computer-implemented method of claim 10, wherein the multi-head attention layer is trained to learn a relevance of the unique code to a state prediction, and an importance of the time differential corresponding to the unique code.

12. The computer-implemented method of claim 9, wherein the attention model is configured based at least in part on a user-specific vector.

13. The computer-implemented method of claim 12, wherein the user-specific vector comprises patient demographic data.

14. The computer-implemented method of claim 12, further comprising:
generating the user-specific vector based at least in part on historical patient data.

15. The computer-implemented method of claim 9, wherein converting each unique code in the unique code set to the code data vector comprises:
for each unique code:
applying the unique code to a trained language model, wherein the trained language model generates the code data vector corresponding to the unique code.

16. The computer-implemented method of claim 9, wherein determining the time differential between the recordation timestamp associated with the instance of the unique code and the sensed timestamp associated with at least the portion of the high-frequency data comprises:
determining the sensed timestamp associated with at least the portion of the high-frequency data, wherein the sensed timestamp comprises one of a first sensed timestamp, a last sensed timestamp, or a predetermined timestamp associated with at least the portion of the high-frequency data.

17. The computer-implemented method of claim 9, further comprising:
generating a scaled time differential based at least in part on the time differential,
wherein the transformed time vector is generated by applying the scaled time differential to the time transformation function.

18. The computer-implemented method of claim 17, wherein generating the scaled time differential comprises applying the time differential to a logarithmic scaling function.

19. An apparatus comprising at least one processor and at least one memory including program code, the at least one memory and the at least one program code configured to, when executed by the at least one processor, cause the apparatus to:
receive high-frequency data associated with a first capture rate and low-frequency data associated with a second capture rate;
generate vectorized low frequency data by converting the low-frequency data using a low-frequency encoding model; and
process, utilizing a prediction model, the high-frequency data and the vectorized low-frequency data to generate output data.

20. A computer program product comprising a non-transitory computer-readable storage medium, the non-transitory computer-readable storage medium including instructions that, when executed by at least one processor, cause the at least one processor to:
receive high-frequency data associated with a first capture rate and low-frequency data associated with a second capture rate;
generate vectorized low frequency data by converting the low-frequency data using a low-frequency encoding model; and
process, utilizing a prediction model, the high-frequency data and the vectorized low-frequency data to generate output data.
